(19) United States
(12) Patent Application Publication
(10) Pub. No.: US 2002/0064221 A1
(43) Pub. Date: May 30, 2002

(54) Apparatus for connecting digital subscriber lines to central office equipment

(76) Inventors: Tet Hin Yeap, Ottawa (CA); John James Schellenberg, Winnipeg (CA)

Correspondence Address: Adams Cassan Maclean, P O Box 11100, Station H, Ottawa, ON, K2H 7T8, CA

(21) Appl. No.: 09/996,767

(22) Filed: Nov. 30, 2001

Related U.S. Application Data
(60) Provisional application No. 60/253,933, filed on Nov. 30, 2000.
(60) Provisional application No. 60/262,058, filed on Jan. 18, 2001.
(60) Provisional application No. 60/288,785, filed on May 7, 2001.
(60) Provisional application No. 60/311,357, filed on Aug. 13, 2001.

(51) Int. Cl. H04L 5/16; H04B 1/38

(52) U.S. Cl. 375/222

(57) ABSTRACT

In order to provide DSL service to more subscribers, at least part of the DSLAM is provided at a location, e.g. an outside plant interface unit (16), that is intermediate the subscriber premises (10₁, . . . 10^{N}) and the central office (13) housing the remainder of the DSLAM. An optical fiber conveys signals between the two parts of the DSLAM, thus reducing the length of the twisted-wire portion of the subscriber loop. To reduce complexity and equipment costs, access apparatus for connecting a plurality of DSL lines to a data network (28) comprises a plurality of interface units connected to a plurality of DSL lines, respectively, for converting high frequency analog signals to digital signals, or vice versa; at least one digital signal processor (DSP) modem (30) for processing the digital signals and routing the processed signals to the data network, and for processing signals from the data network and supplying the resulting digital signals to the interface units, respectively. A session switch (92) my be provided for making virtual connections between respective ones of the interface units whose associated DSL lines are active and the DSP modems. The session switch maintains each connection for the duration of a session. With such an arrangement: a pool of DSPs may be shared by a much larger number of DSL lines.

### TECHNICAL FIELD

The invention relates to apparatus for connecting digital subscriber lines (DSLs) to central office equipment.

### BACKGROUND ART

The existing telecommunications system now is being used to deliver high speed data to/from subscribers using the existing subscriber loops, i.e. which already carry so-called POTS telephone signals. At the subscriber's premises, digital data signals for transmission to the central office are converted, using a high speed modem, to an analog signal having a relatively high frequency, much higher than that of the POTS signal. Conversely, the modem converts high frequency analog signals received from the central office into digital data signals. Both the high frequency signals and the POTS signals travel along the same twisted wire pair, simultaneously if required.

In a typical subdivision, the twisted wire pairs of several subscribers, maybe 10 to 20, are routed to a so-called pedestal. As many as 30 pedestals are connected by a distribution cable to what is known in North America as an outside plant interface (OPI). Within the OPI, connector blocks connect the individual twisted wire pairs to respective conductors of a feeder cable which conveys the signals to and from the central office.

At the central office, a bank of POTS splitters/combiners, conveniently high pass/low pass filters, separate the high frequency analog signals from the POTS signals received from the loops, or combine high frequency analog signals and POTS signals destined for the loops, A POTS switch conveys the POTS signals to and from the public service telephone network (PSTN) in the usual way. The high frequency analog signals are supplied to, or received from, one or more so-called digital subscriber loop access multiplexers (DSLAMs). Each DSLAM comprises analog interface circuitry (usually called “analog front end” (AFE) circuitry) which comprises hybrids, amplifiers, and so on, for processing the high frequency analog signals in the usual way, a bank of analog-to-digital (A-D) converters for digitizing the high frequency analog signals from the DSL lines and supplying the resulting digital data signals to a bank of digital signal processor (DSP) modems and a bank of digital-to-analog (D-A) converters for converting digital data signals from the DSP modem to high frequency analog signals for transmission via the DSLs.

The DSLAM also includes a data network interface unit which conveys the digital data signals to/from the data network using, for example, SONET or ATM protocol. Existing twisted pair subscriber loops were not designed to handle high frequency signals. While the high speed analog signals can usually be transmitted over short subscriber loops with acceptable bit error rates, as a general rule, they cannot be transmitted over longer subscriber loops, since signal attenuation over twisted pairs is a strong function of both frequency and distance, which limits the transmission rate and the distance between the central office and the subscriber. Currently, in North American cities, about three quarters of subscribers can receive ADSL (asynchronous digital subscriber loop) services at sub-rate, i.e. 1-2 Mbps, and only about one quarter can receive full rate ADSL services, at about 6-8 Mbps.

It is not viable, economically, to replace existing twisted wire pair subscriber loops with optical fibers. While it would be possible to install the DSLAM at the outside plant interface (OPI), such an arrangement would not be entirely satisfactory because the DSLAM includes sensitive electronic and optical components requiring temperature control. Cooling fans would require a local AC power supply; which would lead to significant additional expense, especially because of the associated grounding requirement. The DSLAM would also require a relatively large cabinet, which could be difficult to locate near an OPI, Moreover, a DSLAM typically serves a large number of subscribers, so it has a relatively high power consumption.

### DISCLOSURE OF INVENTION

The present invention seeks to ameliorate one or more of these problems and, to this end, provides access equipment in which, in effect, a first part of the DSLAM is located at the central office and a second part is located at a location closer to the subscriber stations, such as at a remote central office or at a junction where a plurality of individual subscriber loops are connected to a distribution cable or a feeder cable.

According to a first aspect of the present invention, there is provided access apparatus for connecting to a data network a plurality of digital subscriber lines for carrying high frequency analog signals to and from subscriber stations, said apparatus comprising a local part and a remote part and means for communicating signals between the local part and remote part via a high speed link, the local part adapted for location at a central office and comprising a data network interface unit for exchanging digital data signals with said data network via a data switch, said remote part being adapted for location at a position intermediate the central office and said subscriber stations and comprising an analog interface unit, the apparatus further comprising a modem unit in one of said local part and remote part and between the data network interface unit and said analog interface unit, said analog interface unit for converting said high frequency analog signals into modulated digital signals and vice versa, and said modem unit for demodulating said modulated digital signals to form digital data signals for supply to said data network interface unit and for modulating said digital data signals to form said modulated digital signals for supply to said analog interface unit.

Preferably, the intermediate position is at a junction, for example a so-called outside plant interface, where a feeder cable from the central office is coupled to several distribution cables, each of which is connected to several twisted wire pairs of individual subscriber stations.

A POTS splitter/combiner may be provided to receive the high frequency analog signals from the analog interface unit and POTS signals from a POTS switch and convey them to the DSL lines, or vice versa.

An advantage of leaving the data network interface unit at the central office is that it is complex and has significant power and environmental requirements.

The data network interface unit (31) may be coupled to a plurality of said second parts, each at a different intermediate position.

In preferred embodiments of the first aspect of the invention, an access unit at the central office provides a plurality of interfaces for conveying different kinds of high speed signals between the DSL lines and the data network interface unit.

The second part may include a multiplexer, for concentrating the high frequency signals before they are conveyed to the central office.

The remote second parts may be coupled to the central office by more than one path, e.g. more than one optical fiber bundle, so as to improve continuity of service.

In known DSLAMs, each DSL has a dedicated high speed DSP modem. This is very expensive, involves high power consumption and is difficult/expensive to upgrade. In addition, it allows only one dedicated specific line code per line, which means that, as standards change, it is necessary to change line cards.

Because existing systems are so hardware intensive, known systems have only a small number of lines per DSLAM. It is believed that, at present, 1344 DSL lines is the maximum and the line cards occupy a rack approximately 2 meters high.

It has been proposed to reduce the number of DSPs for a particular number of DSL lines by sharing each DSP between several DSL lines. Thus, in U.S. Pat. No. 6,084,885 issued Jul. 4, 2000, which is incorporated herein by reference, R. E. Scott disclosed apparatus for sharing a DSP using statistical properties of data received from DSL. From the input splitter, several data streams are routed to a plurality of hybrid circuits capable of operating at high speeds (above 25 kilohertz). A bank of DAA (data access arrangement) interface circuits provide the usual amplification etc. and then supply the data streams to a bank of D-A converters which convert respective ones of the data streams to digital signals and supply them to a digital multiplexer (DMUX). The DMUX is coupled to a DSP which can select only one of the digital signals from the DMUX at any given time. Hence, the DSP is shared by the plurality of data streams. According to Scott, this is feasible because the data is “bursty” in nature. In fact over the time intervals concerned, i.e., during a particular session, DSL signals are not particularly bursty in nature, so any improvement would be limited. Also, the system introduces significant overhead. Consequently, this DSP sharing scheme is not entirely satisfactory.

Accordingly, in embodiments of a second aspect of the invention, there is provided DSL access equipment comprising a pool of DSP modems, a bank of analog interface circuits and circuit switching means for connecting the DSP modems selectively to the subscriber lines for at least the duration of a call.

According to a second aspect of the present invention, there is provided access apparatus for connecting a plurality of DSL lines to a data network, comprising

(i) a plurality of analog interface units (29, . . . 29_{N}) connected to a plurality of DSL lines, respectively, for converting DSL signals to modulated digital signals, or vice versa.

(ii) a set of one or more digital signal processor (DSP) modem units (30₁, . . . , 30_{M}) for processing the modulated digital signals and routing resulting digital data signals to the data network and for processing digital data signals from the data network and supplying the resulting modulated digital signals to respective ones of the analog interface units, and

(iii) circuit switching means (92) for connecting the DSP modem units selectively to the DSL lines for at least the duration of a call.

The switching means may make virtual connections between respective ones of the interface units whose associated DSL lines are active and said one or more DSP modem units, the switching means maintaining each said connection for the duration of a session or call The switching means may select a particular DSL line in response to a signal from an activity processor which detects activity on the DSL lines.

In preferred embodiments of the second aspect of the invention, each interface unit may be arranged to exchange signalling with a subscriber's modem connected thereto by the associated DSL line so as to set up a session and an activity processor in the switching means detects such signalling indicative of the user's desire to establish a session and connects the corresponding DSL to a selected one of the DSP modem units. The activity processor can be programmed so that, in normal circumstances, the duration of the session may be determined by the user, either by setting the session duration at its commencement, or simply by ending the session at will, e.g. by going off-line.

Preferably, each of the DSL lines can be connected to any DSP modem unit that is not busy.

With the present disparity between DSL rates and DSP processing capabilities, each DSP may process signals from several of the DSL lines simultaneously, i.e. a single DSP may implement several modems.

Preferably, the apparatus comprises one or more pools of DSP and a modem unit plurality of groups of said interface units, the interface units in a particular group being connected to said one or more DSP modem pools by means of a high bandwidth communications channel, for example an optical fiber, optical free space link, and so on. Typically, the groups of interface units will be at different physical locations which may be within a particular central office, in remote distribution boxes, or even in different central offices.

Each interface unit then may comprise means for extracting the modulated digital signals and an optical fiber interface for effecting parallel to serial conversion of the modulated digital signals and routing the serial digital signals via the high bandwidth link. Advantageously, this reduces the need for data buses between the interface circuitry and the DSPs, thereby reducing physical requirements and allowing a large number of interface units at remote locations to be connected easily to one DSP pool. The interface circuitry may be arranged to route signals from only active lines onto the high bandwidth data link.

Such a pool of DSP modem units may be provided at each OPI interface and coupled on the one hand to the plurality of DSL lines and on the other hand via a multiplexer/demultiplexer and an optical interface to the central office.

Embodiments of the two aspects of the invention may be combined.

The foregoing and other objects, features, aspects and advantages of the present invention will become more apparent from the following detailed description, taken in conjunction with the accompanying drawings, of preferred embodiments of the invention, which are given by way of example only.

### BRIEF DESCRIPTION OF THE DRAWINGS

FIG. 1, labelled PRIOR ART is a simplified block schematic diagram illustrating an existing central office connecting a plurality of subscriber stations to a “backbone” broadband data network;

FIG. 2 illustrates the components of a digital subscriber loop access multiplexer in the central office of FIG. 1;

FIG. 3 is a simplified block schematic diagram similar to FIG. 1 but illustrating a central office connecting a plurality of subscriber stations to a “backbone” broadband data network using an access apparatus arrangement embodying the present invention;

FIG. 4 is a simplified detail view showing connection of an OPI subsystem in the arrangement of FIG. 3;

FIG. 5 illustrates how components at the central office of FIG. 3 are connected to components at the OPI;

FIG. 6 corresponds to FIG. 5 but illustrates an alternative configuration;

FIG. 7 corresponds to FIG. 3 but illustrates an alternative access arrangement suitable for use with existing DSLAMs (digital subscriber loop access multiplexers) in the central office;

FIG. 8 illustrates interconnection of parts of the access arrangement of FIG. 7;

FIG. 9 illustrates a modification of the access arrangement of FIG. 7 in which modem units are provided at the central office and an OPI subsystem at a remote location;

FIG. 10 illustrates in more detail equipment at the central office and the OPI subsystem;

FIG. 11 illustrates another embodiment of the invention in which the OPI subsystem of FIG. 10 interfaces with a data network interface at the central office;

FIG. 12 illustrates an arrangement for interfacing different kinds of digital subscriber lines carrying different kinds of high speed signals to the same central office;

FIG. 13 illustrates a DSL access subsystem suitable for use in the central office of FIG. 12;

FIG. 14 illustrates a modification to the OPI subsystem or its equivalent to reduce the number of optical interface units;

FIG. 15 illustrates an arrangement for providing redundancy in the connections between the central office and the remote locations;

FIG. 16 is a simplified schematic diagram of a digital subscriber loop access module (DSLAM) having a shared pool of DSP modems;

FIG. 17 is a simplified block diagram of an arrangement in which several banks of analog interface units are coupled to pools of DSPs modems by optical communications channels;

FIG. 18 is a much-simplified block schematic diagram of a system in which banks of analog interface units associated with different central offices are coupled to a common DSP modem pool, FIG. 19 is a much-simplified block schematic diagram of a system similar to that of FIG. 18 but in which some of the central offices are each coupled to analog interface units at associated outside plant interface units;

FIG. 20 illustrates deployment of the DSP sharing equipment at a central office; and

FIG. 21 illustrates an OPI subsystem having a shared pool of DSP modems controlled dynamically by a session switch.

### BEST MODE(S) FOR CARRYING OUT THE INVENTION

In the following description, identical or similar items in the different Figures have the same reference numeral,

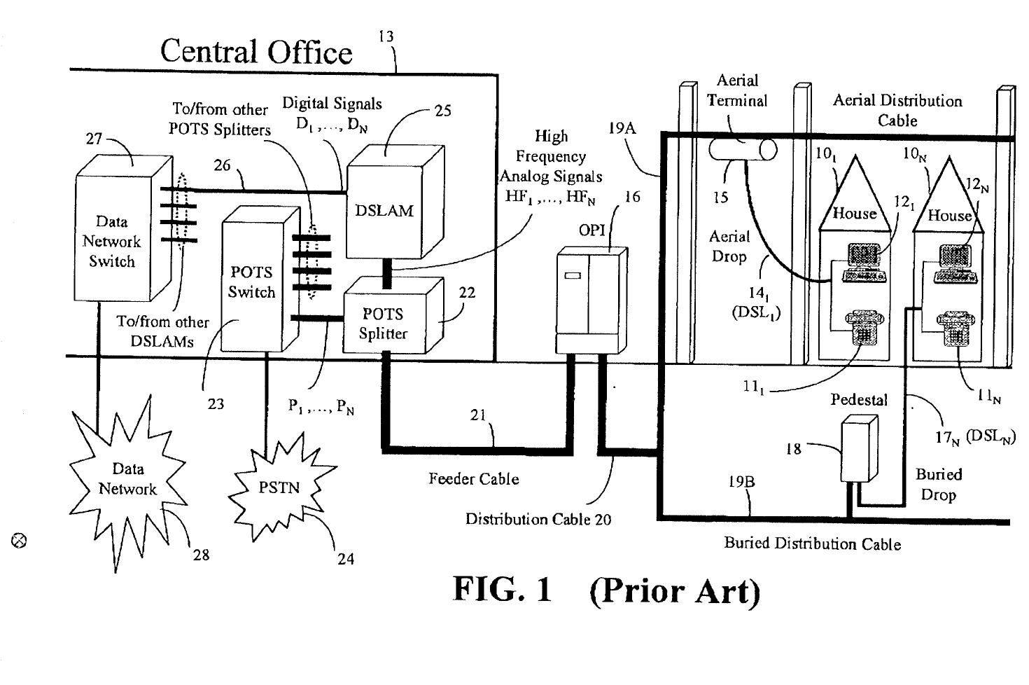

In the portion of the known telecommunications system illustrated in FIG. 1, the station apparatus at the premises 10₁, . . . , 10_{N} of a plurality of subscribers/users comprise, for example, conventional analog telephone sets 11₁, . . . , 11_{N} , respectively, and computers 12₁, . . . 12_{N}, respectively, which are connected to a central office 13 by digital subscriber loops DSL₁, . . . , DSL_{N}, respectively. For simplicity, only premises 10₁ and 10_{N} and the associated subscriber station apparatus are shown. Telephone set 11₁ and computer 12₁ are connected by way of an aerial drop cable 14₁ to an aerial terminal box 15. Telephone set 11_{N} and computer 12, are connected by way of a buried drop cable 17_{N} to a pedestal unit 18. The aerial terminal box 15 and the pedestal unit 18 each connect the station apparatus of, for example, 10 to 20 such subscribers to an outside plant interface (OPI) unit 16 via aerial distribution cable segment 19A and buried distribution cable segment 19B, respectively, and main distribution cable 20.

The OPI 16 itself connects the pairs of conductors in the main distribution cable 20 to corresponding pairs of conductors of a feeder cable 21, which connects to the central office 13.

At the subscriber premises each subscriber loop is connected to both the corresponding one of the telephone sets 11₁, . . . , 11_{N} and the associated one of the computers 12₁, . . . , 12_{N}. Each computer is connected by a high speed modem (not shown) which converts the digital data from the computer to a high frequency analog signal, or vice versa. Typically, the high frequency analog signals HF₁, . . . , H_{N} will have a frequency in the range from about 25 kHz to several megahertz, whereas the POTS (plain old telephone system) signals P₁, . . . , P_{N} forth the conventional telephone sets 11₁, . . . , 11_{N} will be at a much lower frequency, less than 25 kHz.

Within the central office 13, the pairs of conductors of feeder cable 21 terminate at a POTS splitter unit 22 which comprises a bank of lowpass/high pass filters for separating the high frequency analog signals HF₁, . . . , HF_{N} and low frequency POTS telephone signals P₁, . . . , P_{N}. The POTS splitter 22 supplies the POTS signals P₁, . . . , P_{N} to a POTS switch 23 for routing to the conventional telephone network (PSTN) 24, and supplies the high frequency analog signals HF₁, . . . , HF_{N} to a digital subscriber loop access multiplexer (DSLAM) 25.

The DSLAM 25 converts the high frequency analog signals HF₁, . . . , HF_{N} to corresponding digital signals D₁, . . . , D_{N}, respectively, performs framing, converts them to optical format (e.g. SONET or ATM) and then supplies them via optical fiber 26 to data network switch 27 which aggregates optical signals from a plurality of DSLAMs to form an optical signal (e.g. SONET 0C192/ATM) for routing to the broadband “backbone” data network 28, It will be appreciated that the apparatus is bidirectional, i.e. the optical signals from the data network 28 and POTS signals from the PSTN network 24 will be processed and routed in the opposite direction to respective ones of the subscriber loops, the POTS splitter 22 then serving to merge rather than split.

The nature of the data network switch 27 will depend upon the data network 28. It is envisaged that it will be, for example, an Asynchronous Transfer Mode (ATM) switch or a Synchronous Optical Network (SONET) switch.

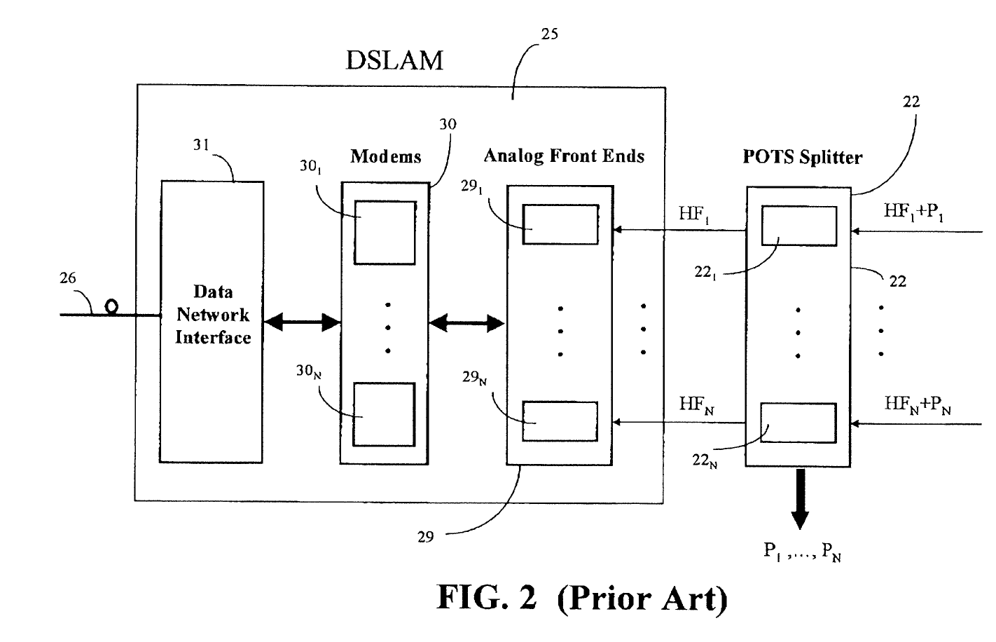

As shown in FIG. 2, the known DSLAM 25 comprises a bank of so-called analog front end (AFE) units 29₁, . . . , 29_{N} connected to a bank of DSP modems 30₁, . . . , 30_{N}, respectively, which are connected to a data network interface unit 31. The POTS splitter unit 22 comprises a bank of POTS splitter filters 22₁, . . . , 22_{N}, which are connected to the AFE units 29₁, . . . , 29_{N}, respectively, and to respective ones of a bank of digital signal processor (DSP) modems 30₁, . . . , 30_{N}, A data network interface unit 31 connects the bank of modems 30₁, . . . , 30_{N} to data network switch 27 (FIG. 1) via optical fiber 26 using, for example, SONET OC12. Each analog front end (AFE) unit comprises analog interface circuitry (hybrids, amplifiers, and so on), for processing high frequency analog signals in the usual way, a bank of analog-to-digital (A-D) converters for digitizing the high frequency analog signals and supplying the resulting digital signals to one of the DSP modems 30₁, . . . , 30_{N}, and a bank of digital-to-analog (D-A) converters for converting digital signals from the DSP modem sets to high frequency analog signals for transmission via the POTS splitter 22 to the subscriber loops. Because the various components of an AFE are known to those skilled in this art, they are not shown and will not be described herein.

The data network interface unit 31, which serves to communicate digital signals between the DSLAM's DSP modems 30₁, . . . , 30_{N} and the data switch 27, may itself comprise a switch using synchronous optical network (SONET), asynchronous transfer mode (ATM), or other technology according to the kind of data network to which the data switch 27 is connected.

It will be appreciated that arrangement is bidirectional i.e. the DSLAM 25 and POTS splitter bank 22 operate in a complementary manner to process signals transmitted from the subscribers and route them to the POTS network 24 and data network 28. It should also be appreciated that, as indicated in FIG. 1, there will usually be many more DSLAMs and POTS splitters coupling other OPIs to the data network switch 27.

Generally, the subscriber loops, designated DSL₁, . . . DSL_{N}, in FIG. 1, each comprise the several concatenated pairs of conductors extending between the corresponding subscriber's station apparatus 11₁, . . . 11_{N} and 12₁, . . . 12_{N} and the DSLAM 25. As mentioned hereinbefore, signal attenuation over twisted wire pair subscriber loops limits the data rate and the distance from the central office (DSLAM) to the subscriber apparatus.

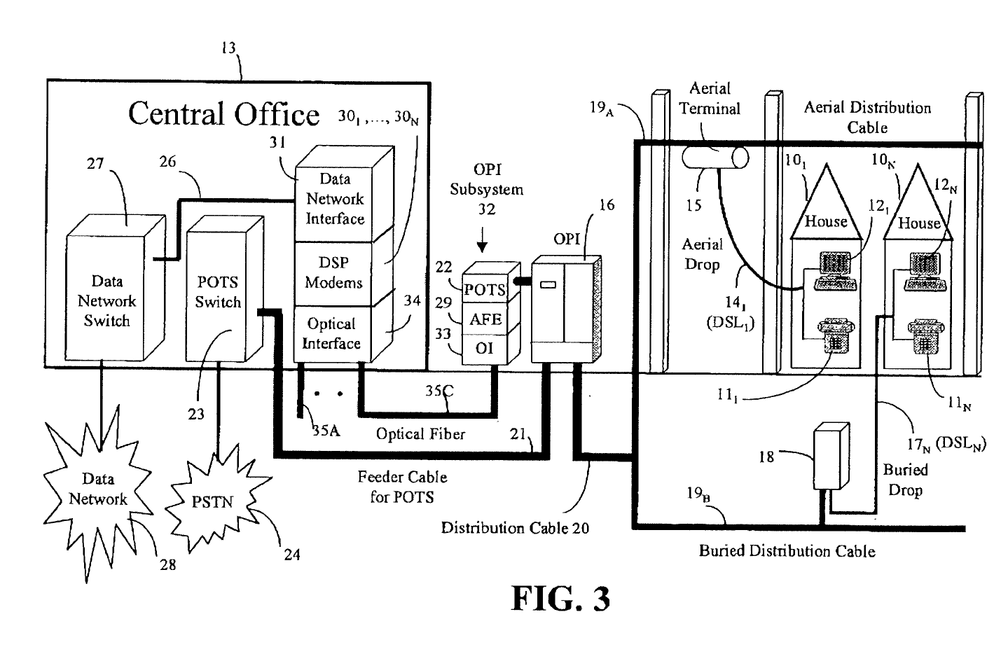

In order to reduce the length of the twisted wire portions of the subscriber loops, therefore, embodiments of the present invention, locate part, but not all, of the DSLAM closer to the subscribers. Such an access arrangement will now be described with reference to FIGS. 3, 4 and 5. The access arrangement illustrated in FIGS. 3, 4 and 5 differs from the arrangement illustrated in FIG. 1 in that the POTS splitter 22 and the bank 29 of analog front end (AFE) units 29₁, . . . , 29_{N}, are located, with an optical interface unit 33, in an OPI subsystem 32 adjacent the OPI unit 16, conveniently on the same plinth; and the remaining DSLAM parts, namely the bank 30 of DSP modems 30₁, . . . , 30_{N} and the network interface unit 31, are located, as before, in the central office 13. An additional optical interface 34 connected to the DSP modem unit 30 (FIG. 3) communicates via an optical fiber bundle 35C with the optical interface unit 33 connected to the bank 29 of AFEs 29₁ . . . , 29N in the OPI subsystem 32 The optical interfaces 33 and 34 may conveniently use SONET, e.g. OC12 or OC48.

The optical interface 34 is coupled to other similar OPI subsystems (not—shown) by additional optical fiber bundles 35A, 35B, 35C, etc.

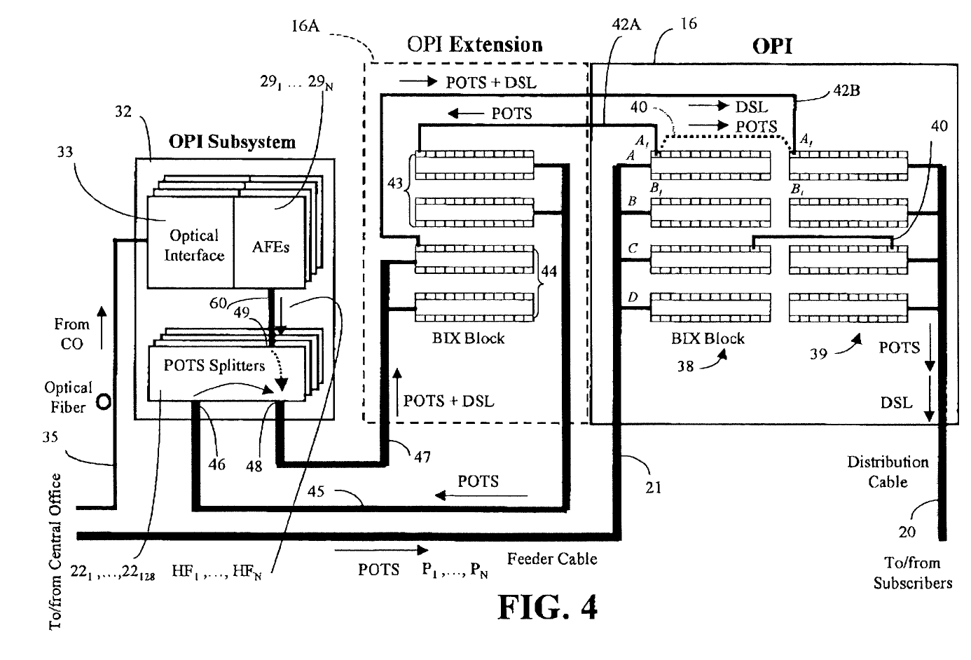

As shown in FIG. 4, the OPT subsystem 32 is coupled to the OPI 16 by an OPI extension unit 16A mounted to the OPI unit 16, either in the same cabinet or attached to it. Within the OPT unit 16, there are the usual two BIX connector blocks 38 and 39, the latter connected to the main distribution cable 20 (FIG. 3) and the former connected to the POTS feeder cable 21.

Usually, the terminals of BIX connector block 38 would be connected to respective ones of the terminals of BIX connector block 39 by jumpers 40 (one only is shown). In FIG. 4, however, some of the jumpers 40, specifically those of subscribers requiring both POTS and DSL service, are omitted (one only is shown by a broken line). They are replaced by sets of conductors 42A and 42B which are connected to “dummy” BIX connector blocks 43 and 44, respectively, in the OPT extension unit 16A. Dummy BIX connector blocks 43 and 44 are smaller than BIX connector blocks 38 and 39 because, at least at present, it is likely that fewer than 20 per cent of the subscribers served by OPI 16 will require DSL service, Of course, as and when necessary, more BIX connector blocks could be added to the OPI extension unit 16A.

The terminals of BIX connector block 43 are connected by conductor pairs of a first, “POTS-only” cable 45 to a first port 46 of the POTS splitter bank 22, while the terminals of BIX connector blocks 44 are connected by conductor pairs of a second, “POTS and DSL” cable 47 to a second port 48 of the POTS splitter bank 22. A third port 49 of the POTS splitter bank 22 is coupled to the bank of AFE circuits 29₁, . . . , 29N which, in turn, are coupled via optical interface unit 33 to optical fiber 35C.

Referring again to FIG. 4, installation of the OPT subsystem 32 and OPT extension unit 16A is possible with minimal disruption of services to individual subscribers. To connect he OPT subsystems 32 to the OPI 16, the technician will remove the first jumper from the first terminals of the BIX connector blocks 38/A and 39/A, respectively, and connect in its place the ends of the bridging conductors 42A and 42B. That completes the conversion of the first subscriber loop from “POTS only” to “POTS and high speed data”, i.e., to become a DSL. Each of the other jumpers can be removed in turn and the corresponding bridging conductors connected in its place. Since only one subscriber loop is disconnected at any given time, and only for the time taken to remove the jumper and connect the two bridging conductors, interruption of service to the subscribers is minimal.

In operation, the optical interface unit 33 converts the optical signals arriving from the central office 13 into modulated digital signals which it supplies to the bank of AFE units 29₁, . . . , 29_{N}. Corresponding analog high frequency data signals HF₁, . . . , HF_{N}, from the AFE units 29₁, . . . , 29_{N}, respectively, are supplied to the POTS splitter bank 22 which routes them, via port 48 and the corresponding conductor pairs of the POTS+DSL cable 47 and BIX connector blocks 44 and 39, to main distribution cable 20 and hence to the subscriber premaises 10₁, . . . , 10_{N}.

Meanwhile, POTS signals P₁, . . . , P_{N}, from the POTS switch 23 (FIG. 3) at the central office 13 will be routed via feeder cable 21 to connector block 38 in the OPI 16 and, from there, via conductors 42A, BIX block 43 in the OPI extension 1 6A, and POTS-only cable 45 to port 48 of the POTS splitter unit 22. The POTS signals P₁, . . . , P_{N} leave the POTS splitter 22 via port 48 and then follow the same path to the subscribers as the high frequency analog signals HF₁, . . . , HF_{N}.

It will be appreciated that DSL and POTS signals from the subscribers to the central office will follow the same paths, respectively, but in the opposite direction.

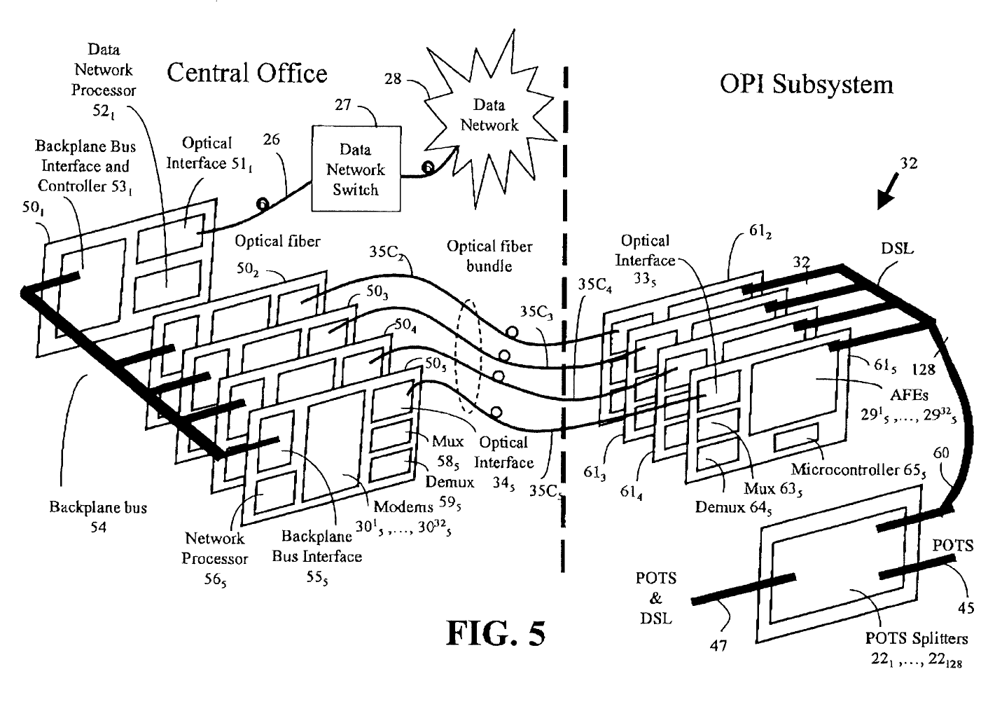

As shown in FIG. 5, the network interface unit 31, DSP modem bank 30 and optical interface unit 34 are distributed among a set of printed circuit cards. The data network interface 31, carried by card 501, comprises an optical interface circuit 51₁, a data network processor 52₁ and a backplane bus interface and controller unit 53₁. The optical interface circuit 51₁ is connected by optical fiber 26 and switch 27 to backbone data network 28, and converts optical (e.g. ATM or SONET) signals received from the switch 27 into electrical serial digital signals which it supplies to the data network processor 52₁. The latter performs de-framing and demultiplexing to provide a set of parallel packetized digital data signals with subscriber-specific addressing, which the backplane bus interface and controller 53₁ routes via backplane bus 54 to appropriate ones of the DSP modems, which are in four sets on cards 50₂, 50₃, 50₄ and 50₅, respectively.

Since cards 50₂, 50₃, 50₄ and 50₅ are of identical construction, only card 50₅ will be described. Thus, card 50₅ carries a backplane bus interface unit 55₅, a network processor 56₅, a set of thirty-two DSP modems 30₅¹, . . . , 30₅³², a multiplexer 58₅, a demultiplexer 59₅ and an optical (SONET) interface 34₅. The backplane bus interface unit 55₅ controls the flow of signals between backplane bus 54 and network processor 56,, which detects packet addresses in the digital data signals and routes the digital data signals to appropriate ones of the modems 30₅¹, . . . , 30₅³².

The modems 30₅¹, . . . , 30₅³², modulate the digital data signals to form modulated digital signals and supply them to the multiplexer 58₅ which multiplexes them to form a serial signal. Optical interface 34, converts the serial signal to a corresponding SONET optical signal, SONET OC 12 for example, and transmits the optical signal via the optical fibre 35C₅ to the OPI subsystem 32.

The OPI subsystem 32 comprises a bank of complementary cards 61₂, . . . , 61₅ each carrying a bank of individual AFE circuits and coupled to a respective one of the cards 50₂, . . . , 50₅ by a corresponding one of the bundle of optical fibers 35C₂, . . . , 35C₅. Because AFE cards 61₂, . . . , 61₅ are identical, only one will now be described. Thus, AFE card 61₅ cares an optical interface circuit 33₅, a multiplexer 63₅, a demultiplexer 64₅, a bank of thirty-two AFE circuits 29₅¹, . . . , 29₅³², and a microcontroller 65₅ which controls the other components on the card 61₅.

The optical interface circuit 335 converts the serial optical signal from fibre 35C₅ into a serial electrical digital signal, de-frames it, etc., and supplies the resulting serial digital signal to demultiplexer 64₅. The demultiplexer 64₅ demultiplexes the serial digital signal and supplies the resulting individual modulated digital signals to respective ones of the bank of AFE circuits 29₅¹, . . . , 29₅³². The AFE circuits 29₅¹, . . . , 29₅³² convert the modulated digital signals to analog high frequency signals and supply them via cable 60 to the bank of POTS splitters 22₁, . . . , 22₁₂₈ for routing onto the POTS and DSL cable 47. The cable 47 also carries the POTS signal from cable 45 (FIG. 4) as discussed previously.

It will be appreciated that high frequency analog signals coming from the subscribers via cable 60 can be processed in the opposite direction by the AFE circuits, multiplexed by multiplexers 63₅, converted by optical interface 33, into a SONET optical signal and routed to the central office 13. Likewise, in the central office 13, the optical interface 34₅ will convert the received optical signal and supply the corresponding electrical serial digital signal to demultiplexers 595, The demultiplexers 59₅ has 32 outputs each coupled to a respective one of the modems. Following processing by the modems, the signals will be routed via the network processor 565 and the backplane bus interface unit 55₅ onto the backplane bus 54.

It should also be noted that each of the optical interfaces 34₂, . . . , 34₅ at the central office 13 and the corresponding one of the optical interfaces 33₂, . . . , 33₅ at the OPI subsystem 32 exchange optical signals via a single optical fiber, i.e. bidirectionally, using different wavelengths for signals travelling in opposite directions. It would be possible, of course, for them to use two optical fibers, one for each direction, but that would increase cost significantly.

It would also be possible to use wavelength division multiplexing (WDM) to reduce the number of optical fibers but, at least at present, the added complexity is not justified. Moreover, it is envisaged that embodiments of the invention using a different wavelength in each direction, but without multiplexing, would integrate more readily with passive optical technology proposed for use as and when optical fiber replaces the twisted wire pair subscriber loops.

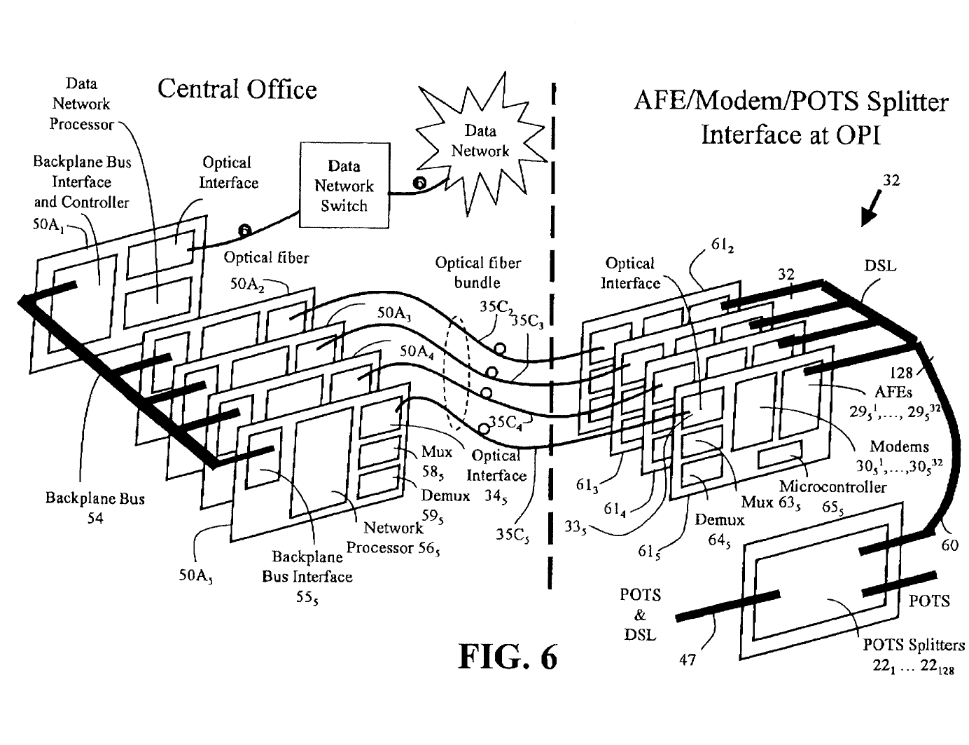

It is envisaged that, in certain circumstances, other components of the DSLAM unit could be transferred to the OPI subsystem 32. Thus, FIG. 6 illustrates how the arrangement of FIG. 5 may be modified by moving the DSP modems from the central office 13 to the OPI subsystem 32. In the arrangement of FIG. 6, the portion of the data network interface unit 31 carried by card 50A, is the same as that shown in FIG. 5. The cards 50A₂, . . . , 50A₅, however, comprise only backplane bus interfaces 55₂, . . . , 55₅, respectively, network processors 56₂, . . . , 56₅, respectively, multiplexers 58₂, . . . , 58₅, respectively, demultiplexers 59₂, . . . , 59₅, respectively, and optical interfaces 34₂, . . . , 34₅, respectively, these components being substantially the same as those in FIG. 5.

As before, the network processors 56₂, . . . , 56₅ decipher the addressing in the parallel digital signals from the backplane bus interface and controller 53₁. In this case, however, the packetized digital signals, which still include the addressing for the respective modems, are multiplexed by multiplexers 58₂, . . . , 58₅, the multiplexed signals converted to optical signals by the optical interfaces 34₂, . . . , 34₅, respectively, and the optical signals transmitted to the OPI subsystem 32.

It should be noted that, in this case, the optical signals that are carried by the optical fibres 35C₂, . . . , 35C₅ comprise the “raw” packetized data signals, so each has a lower bandwidth than the signals carried by these optical fibers in the embodiment of FIG. 5, typically one quarter to one tenth. The actual bandwidth will depend upon the modem and particular protocol involved.

In the OPI subsystem 32, the optical signals from fibers 35C₂, . . . , 35C₅ are converted by optical interfaces 33₂, . . . , 33₅ and demultiplexed by demultiplexers 64₂, . . . , 64₅, respectively, to form corresponding sets of demultiplexed digital data signals. The demultiplexers 64₂, . . . , 64₅ supply their sets of demultiplexed digital data signals to the sets of DSP modems 30₂¹, . . . , 30₂³²; 30₃¹, . . . , 30₃³²; 30 ⁴¹, . . . , 30₄ ³²; 30₅¹, . . . 30⁵³², respectively, which convert the digital data signals to corresponding modulated digital signals and supply them to respective ones of the sets of AFE circuits 29₂¹, . . . , 29₂³²; 29₃¹, . . . , 29₃³²; 29₄¹, . . . , 29₄³²; 29₅¹, . . . , 29₅³². As before, the AFE circuits supply the resulting high frequency analog signals to the POTS splitter bank 22₁, . . . 22₁₂₈. Microcontrollers 65₂, . . . , 65₅ control the various components on their respective cards, as before, and other connections, routings, etc. are similar to those in the embodiment of FIG. 5.

It should be noted that the data network interface unit 31 (FIG. 2) is a complicated piece of equipment because it needs to be able to process different kinds of signals to facilitate, for example, video conferencing, broadcasting and so on. For this reason, it is better to locate it at the central office 13 rather than at the OPI unit 16 or OPI subsystem 32.

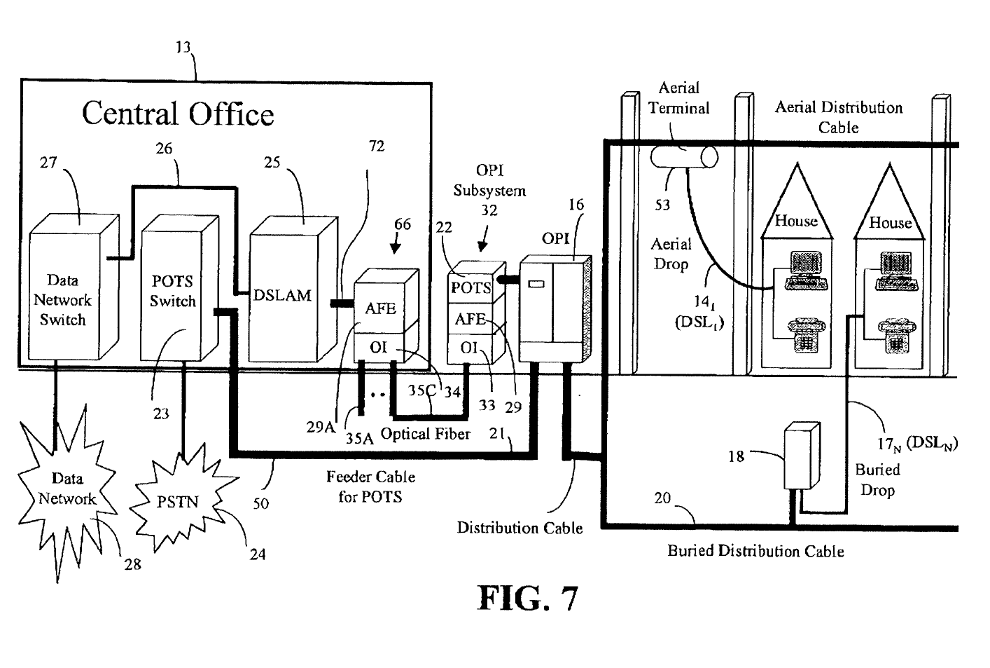

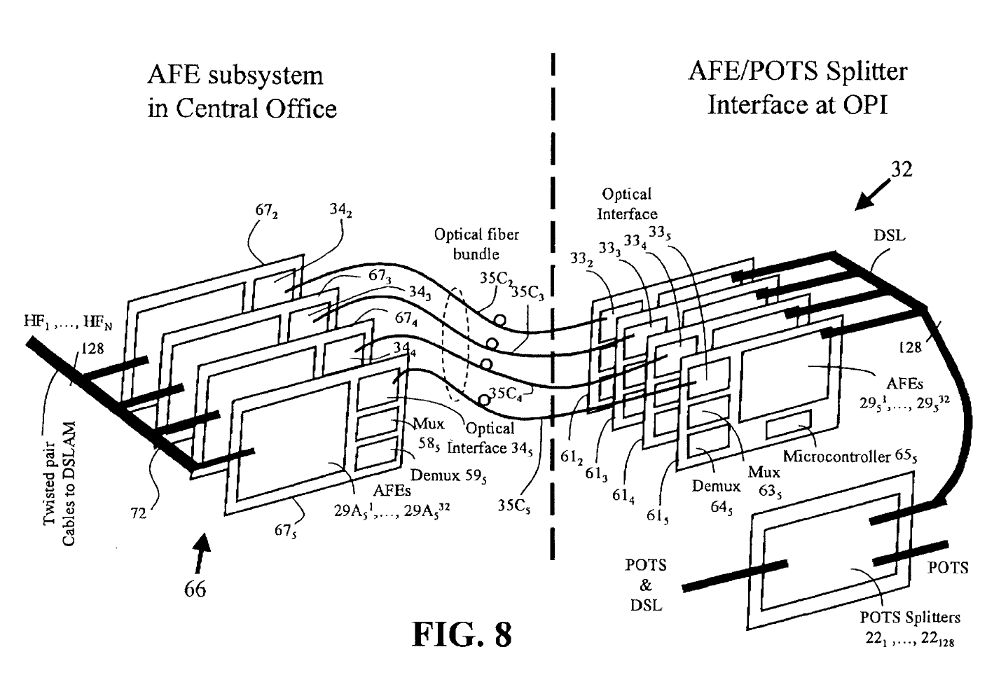

FIGS. 7 and 8 illustrate a further embodiment of the invention which is for use when central office 13 has a D SLAM 25 whose interior is not accessible for one reason or another. The difference between the equipment at the central office 30 shown in FIG. 7 and that shown in FIG. 1 is that the POTS splitter 22 is replaced by a supplemental “reverse” AFE unit 66 coupled to the output of DSLAM 25 by a cable 72 comprising, for example, 128 twisted wire pairs. As shown in FIG. 8, the reverse AFE unit 66 comprises a bank of cards 67₂, . . . , 67₅ carrying AFE circuit groups 29A₂¹, . . . 29A³²; . . . ; 29A₅¹, . . . 29A₅³², respectively, multiplexers 58₂, . . . , 58₅, respectively, demultiplexers 59₂, . . . , 59₅, respectively, and optical interfaces 34₂, . . . , 34₅.

The sets of analog high-frequency signals HF₁, . . . , HF_{N} from the conventional DSLAM 25 are supplied via twisted pair cable 72 to respective ones of the sets of “reverse” AFE circuit groups 29A₂¹, .,29A₂³²; . . . ; 29A₅¹, . . . 29A₅³² which convert the analog high-frequency signals into high-frequency modulated digital signals. Each of the multiplexers 58₂, . . . , 58₅ multiplexes the high-frequency modulated digital signals from the associated one of the reverse APE circuits to form a serial signal which the associated one of the optical interfaces 34₂, . . . 34₅ converts to, for example, a SONET OC48 optical signal. The optical signals are supplied via optical fibers 35C₂, . . . , 35C₅ to an OPI subsystem 32 that is substantially identical to that described with reference to FIG. 5.

Although the addition of the “reverse” AFE unit 66 involves additional cost, it is justifiable in situations where it is not economically viable, for example, to replace the DSLAM 25 and yet, for proprietary reasons perhaps, the DSLAM 25 cannot be opened up and modified. Of course, if access to an existing DSLAM 25 is permitted, or if a DSLAM manufacturer wishes to implement this invention, then the usual cards carrying the modem unit and AFE unit could be replaced by cards 50₂, . . . , 50₅ (FIG. 5) or, if the modem unit is in the OPI subsystem, with cards 50A₂, . . . , 50A₅ (FIG. 6).

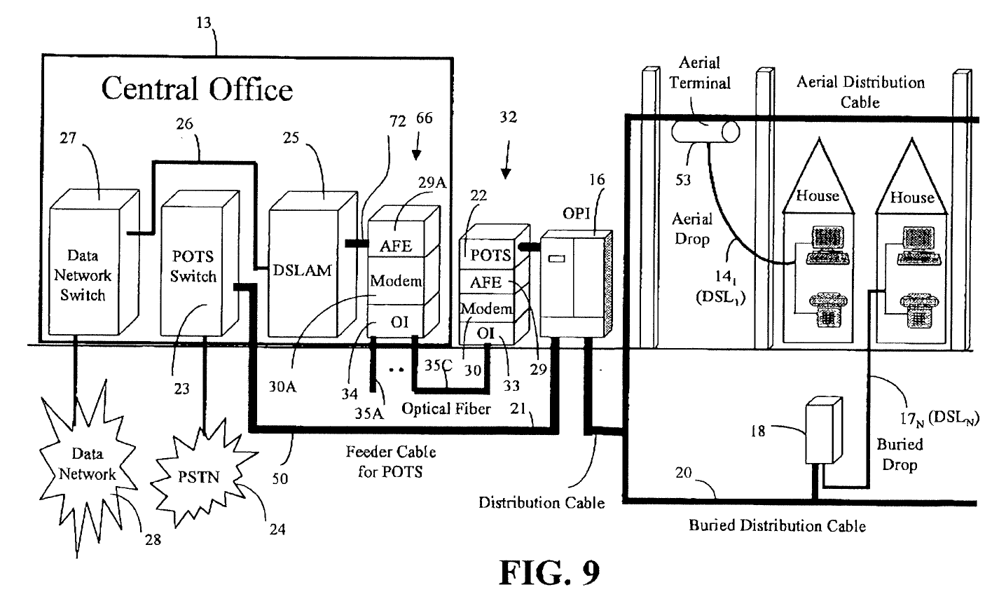

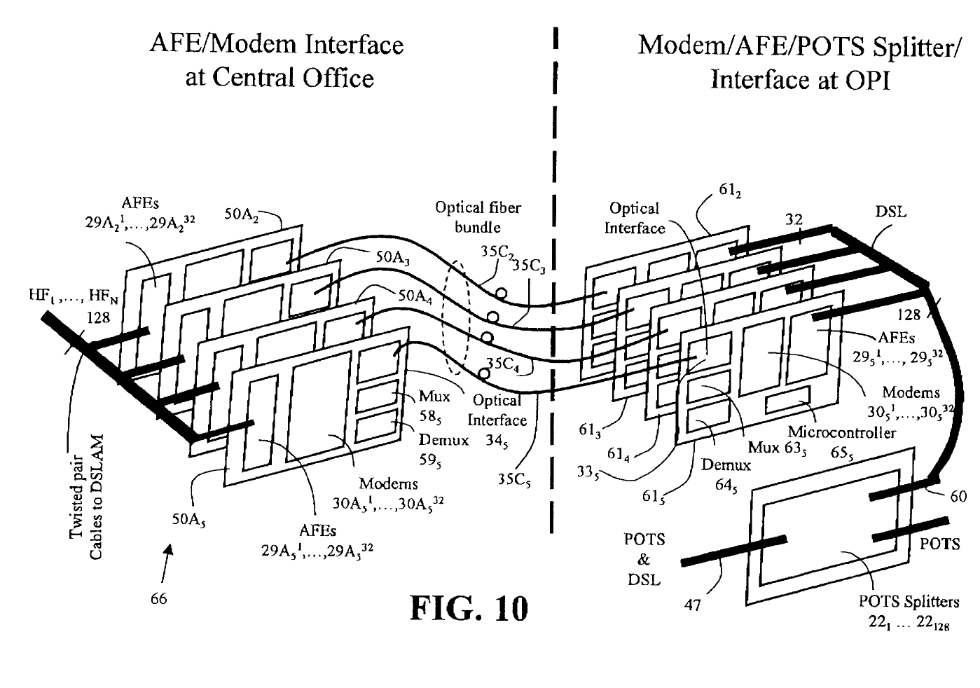

FIGS. 9 and 10 illustrate a modification to the arrangement of FIGS. 7 and 8 to reduce further the bandwidth required for the optical link between the central office 13 and the OPI subsystem 32, specifically by adding a bank of modems 30 to OPI subsystem 32 and a similar bank of modems 30A to the reverse AFE unit 66 in the central office 30, as shown in FIGS. 9 and 10. With such an arrangement, the modulated digital signal samples from the AFE circuits 29A₂¹, . . . , 29A²³² . . . ; 29A₅¹, . . . 29A₅³² are demodulated by respective ones of the modems 30A²¹, . . . , 30A₂³²; . . . ; 30A₅¹, . . . 30A₅³², each to form a corresponding digital data signal having a lower transmission rate, say one quarter to one tenth. For example, the data rate of the modulated digital signal samples might be as much as 4 to 10 times higher than the data rate of the demodulated digital signal. The demodulated digital data signals are multiplexed by multiplexers 58₂,. . . 58₅, converted to optical signals by the optical interfaces 34₂, . . . 34₅, respectively, and transmitted to the OPI subsystem 32.

In the OPI subsystem 32, the optical signals are converted by optical interfaces 33₂, . . . 33₅ to electrical signals, demultiplexed by demultiplexers 642,. . . 643, modulated by the modems 30₂¹, . . . , 30₂³² . . . ; 30₅¹, . . . 30₅³², respectively, and the corresponding modulated digital signals supplied to respective ones of the AFE circuits 29₂¹, . . . , 29₂³², . . . ; 29₅¹, . . . 29₅³², for processing, following which they are supplied via cable 60 to the POTS splitters 22₁, . . . 22₁₂₈, respectively. Signals from the POTS splitters 22₁, . . . 22₁₂₈ to the central office 13 will be processed in a reciprocal manner.

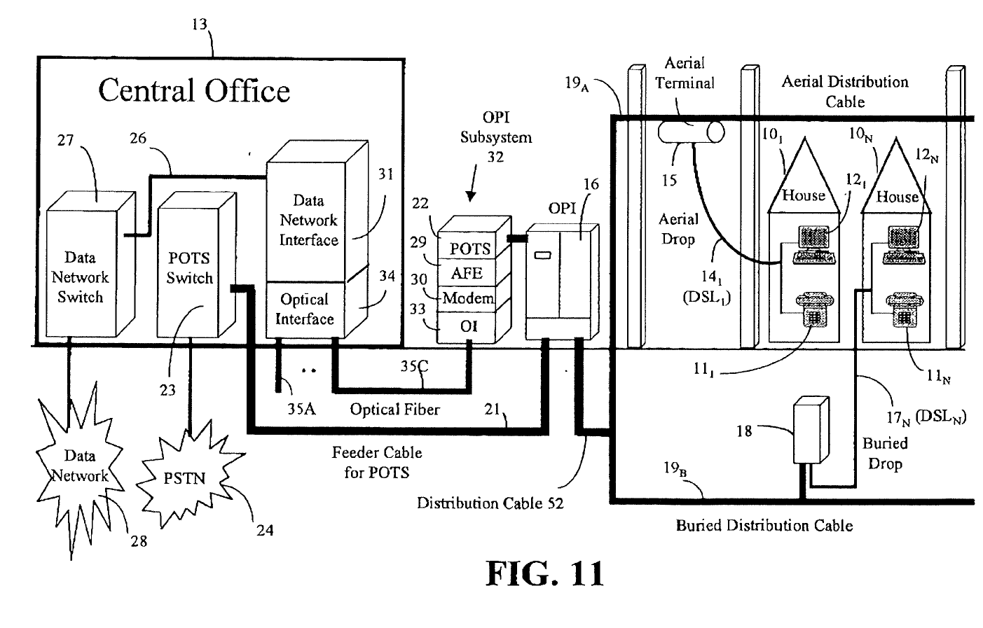

It should be appreciated that the OPI subsystem 32 of FIGS. 9 and 10 could be used where a central office 13 does not have a DSLAM 25 and reverse AFE unit 66, but has only the data network interface part 31 of the DSLAM. Thus, as shown in FIG. 11, the AFE unit 29 at the OPI subsystem 32 could be connected, via modem bank 30, optical interface 33 and optical fiber bundle 35 to an optical interface 34 associated with the data network interface 31 at the central office 13. In essence, the data network interface unit 31, the modem bank 30 and AFE unit 29 at the OPI subsystem 32 constitute parts of a distributed DSLAM, with optical interfaces 33 and 34 and optical fiber 35C interconnecting the parts. The cards at the central office 13 would be similar to the cards 50A₂, . . . , 50A₅ in the arrangement of FIG. 6.

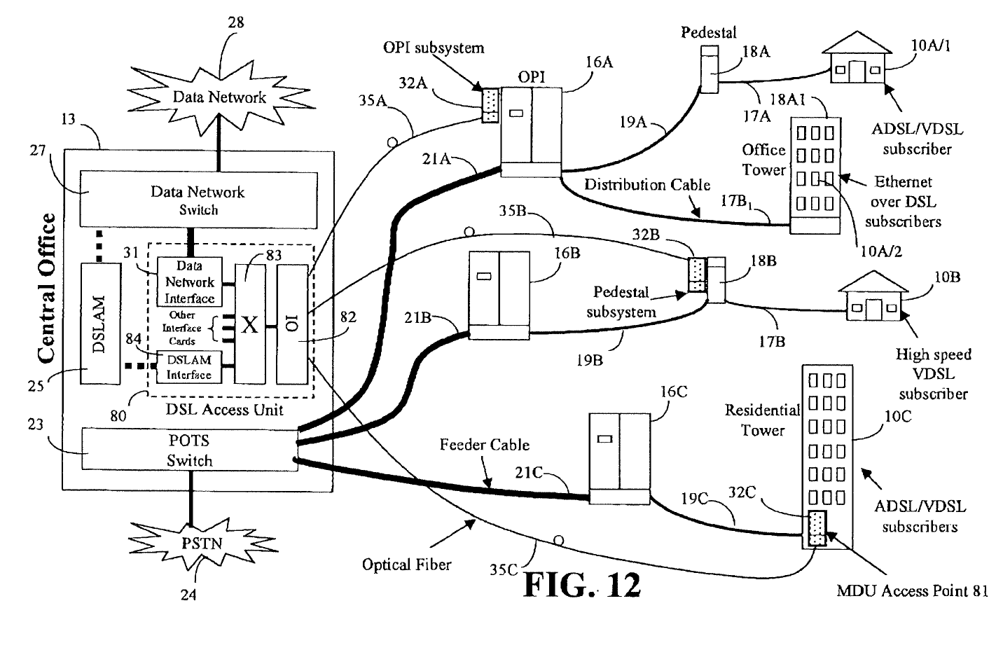

It should be noted that, in each of the foregoing embodiments of the invention, there is a single DSLAM per OPI 16, even though one or more parts of the DSLAM are at the central office 13 and other parts are at the OPI subsystem 32. At present, however, relatively few of the subscribers served by a particular OPI 16 will require DSL. Consequently, whether the whole DSLAM is at the central office, as is the case with existing installations, or the whole DSLAM is at the OPI 16, as has been proposed by others, or the DSLAM is split between central office 13 and OPI 16, as in the embodiments described hereinbefore, it is likely that each DSLAM will be underutilized. A access arrangement which addresses this problem of under utilization will now be described with respect to FIG. 12.

In the arrangement shown in FIG. 12, a central office 13 serves several DSL subscriber stations 10A/1, 10A/2, 10B and 10C by way of OPI units 16A, 16F3 and 16C, respectively. OPI units 16A and 166B are shown connected via pedestal units 18A and 18B, respectively, to sets of subscribers, while OPI unit 16C is shown connected directly to a multiple dwelling unit (NDU). Although only four subscriber residences 10A/1, 10A/2, 10B and 10C are shown in FIG. 12, for simplicity of description, in practice a pedestal unit typically will connect to about 10 subscriber stations while an OPI unit will connect to between 500 and 1,000 subscriber stations.

Each of the OPI units 16A, . . . , 16C will have an AFE subsystem (not shown) associated with it, through not necessarily at the same physical location. The AFE subsystem could be any of those described hereinbefore. Thus, in the access arrangement shown in FIG. 12, a first OPI 16A has a co-located OPI subsystem 32A connected to the central office 13 by an optical fiber bundle 35A. The OPI 16A is connected to ADSL/VDSL subscribers (only one is shown) 10A via a pedestal 18A and directly to an office tower 18A, by a distribution drop cable 17B₁, for delivery of Ethernet over DSL service to occupants of the office tower 18A1.

A second OPI 16B is shown connected to central office 13 and via a second pedestal unit 18B to VDSL subscribers 10B (only one is shown). In this case, the associated OPI unit 32B is co-located with the pedestal unit 188B and connected to the central office 13 directly by an optical fiber bundle 35B. Providing the copper subscriber loop segments between the pedestal unit 18B and the subscriber premises, i.e., including the aerial drops or buried drops 17B, are no longer than about 300 meters, VDSL service at as much as 55 Mb/s could be delivered to the subscriber 10B.

A third OPI 16C is shown connected to the central office 13 by the usual feeder cable 21C and to a multiple dwelling unit (MDU) 10C by a distribution cable 19C. At an access point 81 in the basement of the MDU 10C, the distribution cable/drop 19C is connected to an OPI subsystem 32C which is connected directly to the central office 13 by an optical fiber bundle 35C.

It should be appreciated that the three access configurations, A, B and C shown in FIG. 12 are examples only. They may be modified or combined in various ways according to the kinds of subscriber to be served and the particular services to be delivered. For example, the pedestal unit 18A also could have an OPI subsystem associated with it and connected to the central office directly by an optical fiber bundle.

The three OPI subsystems 32A, 32B and 32C may be any combination of those disclosed hereinbefore, and need not be identical to each other.

At the central office 13, the feeder cables 21A, 21B and 21C are connected to a POTS switch 23 in the usual way. The optical fiber bundles 35A, 35B and 35C, however, are connected to a universal DSL access unit 80 which couples their DSL signals directly to the data network switch 27. The DSL access unit 80 also is connected via a DSLAM 25 to the data network switch 27, to allow for those situations where there is excess capacity in the existing DSLAM 25, in which case DSL access unit 80 routes the incoming digital signals to the DSLAM interface unit 84 which converts them to high frequency analog signals and supplies them to the DSLAM 25. The latter processes them in the usual way before supplying corresponding data signals to the data network switch 27. The DSLAM 25 and DSLAM interface unit 27 are, of course, bidirectional,

It should be noted that the DSL access unit 80 is able to connect to many OPI subsystems 32 distributed over a wide region. Hence it can serve as an aggregator.

The DSL access unit 80 comprises an optical interface unit 82, a configuration switch 83, a data network interface unit 31 and a DSLAM interface unit 84.

The optical interface unit 82 converts the serial signals received from the corresponding one of the optical fibers to electrical data signals and demultiplexes them; or, conversely, multiplexes and converts signals destined for the DSL subscribers. The configuration switch 83 routes the signals from the optical interface unit 82 to the data network interface unit 31 or to the DSLAM interface unit 84 as appropriate; or vice versa. The configuration switch 83 usually will be controlled in known manner, using an Element Management System (not shown), to couple the optical interfaces to the interface cards selectively and to provide any required traffic shaping, or bandwidth allocation.

The DSL access unit 80 may be configured to handle several different kinds of DSL signal.

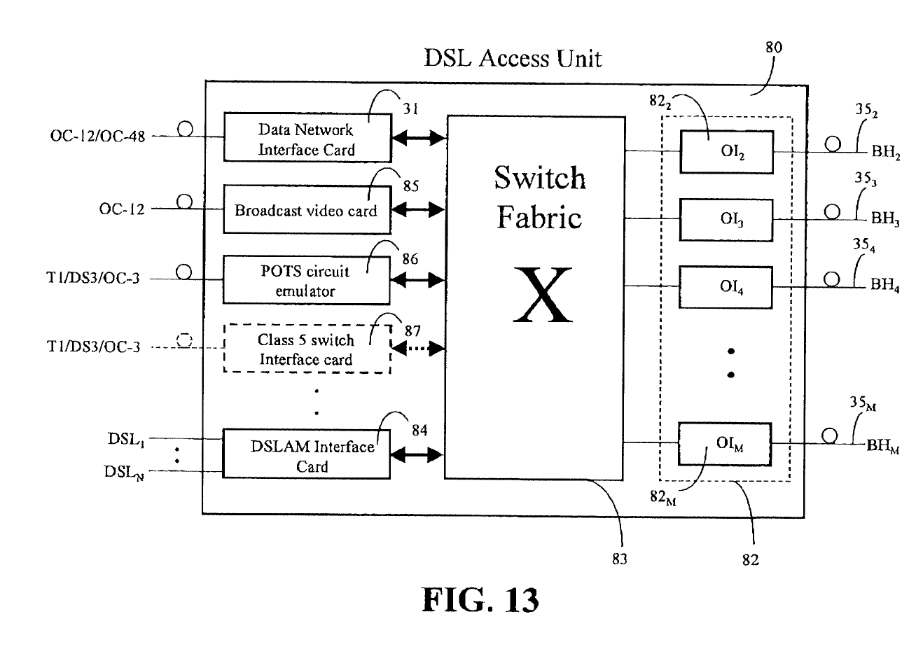

As shown in FIG. 13, for example; in addition to the data network interface unit 31 and the DSLAM interface unit 84, the DSL access unit 80 may comprise a broadcast video unit 85, a POTS circuit emulator 86 and a class 5 switch interface unit 87. Although FIG. 12 shows only three optical fibers 35A, 35B and 35C, in practice, the optical interface unit 82 interfaces with several optical fiber bundles 35₂, . . . , 35_{M} which are connected to separate OPI subsystems, respectively. The subscriber stations requiring DSL services could be using ADSL, VDSL, Ethernet, or other suitable communications protocol. As can be seen from FIGS. 12 and 13, the DSL access unit 80 allows multiple users to share a single data network interface unit 31. Since the latter is the most expensive part of the DSLAM, this improved utilization represents a significant cost saving. In addition, the DSLAM interface unit 84 allows some of the users to be connected to an existing DSLAM 25, if appropriate.

As shown in FIG. 13 each of the optical fiber bundles 35₂ to 35_{M} is coupled to a respective one of the optical interfaces 82₂, . . . , 82_{M}. The switch unit 83 couples them to the output units/cards 31, 85, 86 and 87 according to the particular protocol to be provided. The data network interface card 3 1, interactive or broadcast video card 85, POTS circuit emulator card 86 and DSLAM interface card 84 are connected to, respectively, an OC12/OC48 fiber, an OC12 fiber, a T1/DS3/OC3 connection, and a series of DSL analog signal lines DSL₁, . . . DSL_{N}.

The switch unit 83 may comprise an asynchronous transfer mode (ATM) switch, or equivalent, which is configured by way of an Element Management System (EMS—not shown) to connect any of the optical interfaces 82₂, . . . , 82_{M} to any one of the cards 31 and 84-87, the particular connection made being determined by the service provider's administrator according to the subscriber's service to be delivered. The card 31, i.e. the data network interface card, provides an interface to the data network switch 27 shown in FIG. 12. The interactive or broadcast video card 85 will provide more functionality as appropriate and interface to a broadband video network (not shown).

The POTS circuit emulator card 86 is used to provide voice service, i.e. POTS service, over the DSL line, which may be desirable if a subscriber needs a second line for voice, and will connect to the POTS switch 23.

The DSLAM interface card 84 will comprise a DSL modem and an APE for interfacing to the DSLAM 25, i.e. it is a reverse AFE unit similar to that shown in FIG. 10. The class 5 switch interface unit 87 may be provided for routing ATM traffic or the like between the DSL subscribers and one or more class 5 switches.

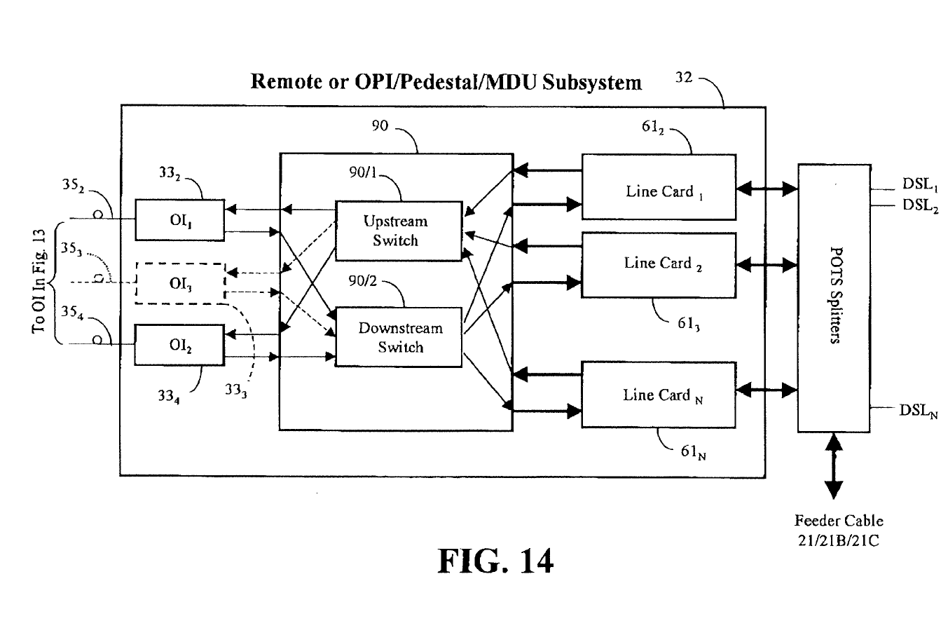

It is also envisaged that the number of optical fibers 35₂, . . . 35_{M} and optical interfaces 82₂, . . . , 82_{M} could be reduced, or redundancy introduced so as to improve continuity of service, by means of a statistical multiplexer switch unit 90 at the OPI subsystem. As shown in FIG. 14, such a statistical switch unit 90 could comprise an upstream switch 90/1 and a downstream switch 90/2, each connected between the optical interfaces 33₂, . . . , 33₄ and the bank of line cards 61₂, . . . , 61_{N} which may be any of those shown in FIGS. 5, 6, 8 and 10 it should be noted that there are fewer optical interfaces than in the embodiments of FIGS. 5, 6, 8 and 10. The optical interfaces 332). . . 334 are shown connected to optical fibers 3 52,,. . . 3 5, respectively, which are connected to the central office 13.

The statistical multiplexer switches 90/1 and 90/2 may each comprise a small ATM switch.

In operation, the switches 9011 and 90/2 will route the active DSL signals to selected ones of the optical fibers 35₂, . . . , 35₄. This allows a number of different configurations. For example, if there is only one optical fiber 35, and optical interface 33., the statistical switch could route to it all of the DSL signals “active” at any given time.

The use of such a switch unit 90 allows the customer to increase the transport capacity of the OPI subsystem by plugging more optical interfaces into the DSL access unit.

If there were two or more optical fibers and optical interfaces, the switch could share the DSL traffic between them equally, or in any other desired proportions.

Where there are two or more optical fibers, one could be used to provide redundancy, and even take a different route to the central office 13, so as to reduce the risk of loss of service caused by equipment failure or damage to the optical fiber cable.

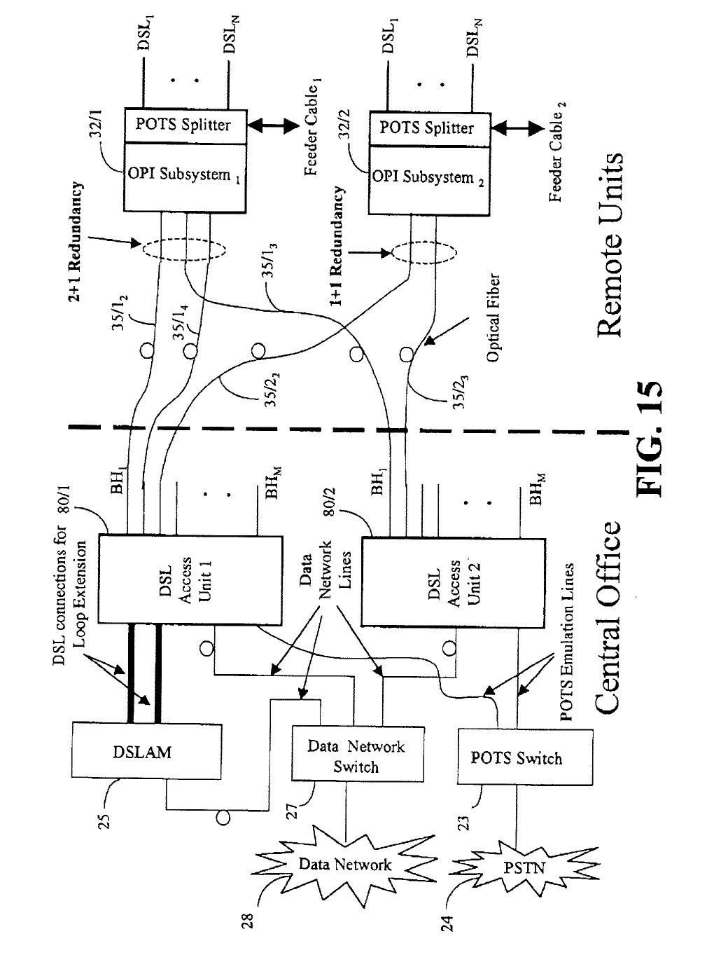

FIG. 15 illustrates how such redundancy could be achieved using two DSL access units 80/1 and 80/2 at the central office 13, both connected to the data network switch 27 directly. DSL access unit 80o1 also is connected via conventional DSLAM 25 and DSL access unit 80/2 also is connected to POTS switch 23 so as to provide for a second or a third POTS service over DSL.

A first OPI subsystem 32/1 is coupled to DSL access unit 80/1 by two optical fibers 35/12 and 35/14 and to the other DSL access unit 8012 by a third optical fiber 35/13, providing 2+1 redundancy in the interconnections. OPI subsystem 32/2 is connected to DSL access unit 80/2 by a first optical fiber 35/23, and to the DSL access unit 8011 by a second optical fiber 35/22, providing 1+1 redundancy in the interconnections.

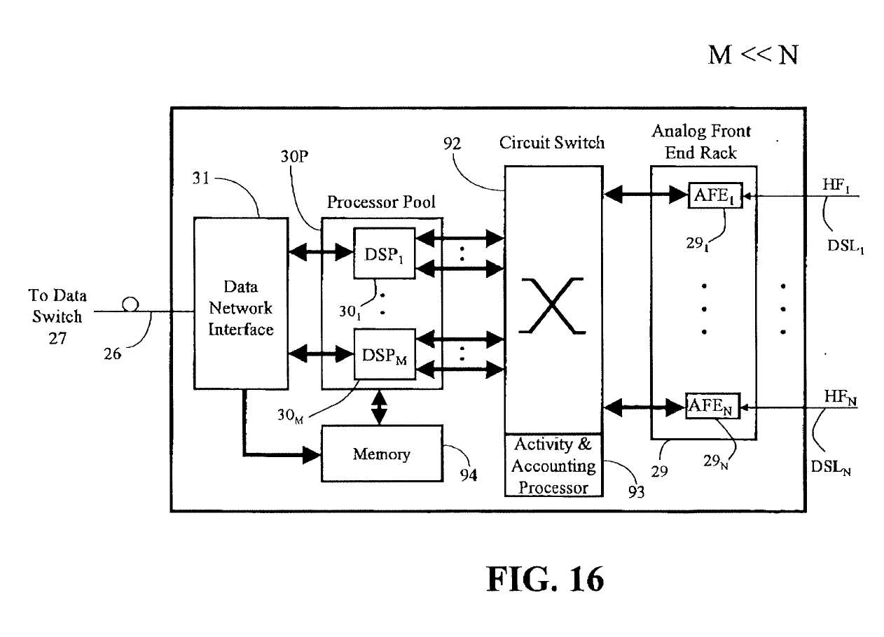

In existing DSL systems, each channel of the DSLAM 25 is dedicated to a respective one of the subscriber loops DSL₁, . . . , DSL_{N}, as are each channel of the DSLAM 25 or DSP modem bank/AFE unit in the above-described embodiments of the present invention As explained hereinbefore, disadvantages of such dedication include cost and lack of flexibility. Embodiments of a second aspect of the invention, which address these disadvantages and maybe combined with the above-described embodiments so as to improve economics and flexibility, will now be described with respect to FIGS. 16 to 20 Thus, FIG. 16 illustrates a DSLAM which may replace one or each of the DSLAMs in the central office 13 in FIG. 1, i.e., which may be connected between the POTS splitter 22 and the switching device 27, or in a comparable location in the embodiment illustrated in FIG. 3. In principle, the embodiment of FIG. 16 could be used in any of the above-described embodiments of the invention but, in practice, would only be used where the modem unit was at the central office 13.

The DSLAM shown in FIG. 16 comprises an AFE unit 29 comprising a bank of analog interface units 29₁, . . . , 29_{N} connected to the digital subscriber loops DSL₁, . . ., DSL_{N}, respectively, a pool 30P of digital signal processor modems 30₁, . . . , 30_{M}, a circuit switch 92 connected between the analog interface units 29₁, . . . , 29_{N} and the modems 30₁, . . . , 30_{M}, and a network interface unit 31 connecting the modems 30₁, . . . , 30_{M} to the network switch 27 (FIG. 1) via an optical fiber 26. An activity and accounting processor 93 associated with the circuit switch 92 monitors the analog interface units 29₁, . . . , 29_{N} for activity on the loops DSLI, ., DSLN and, when activity is detected, controls the session switch 92 to connect the corresponding one of the analog interface units 29₁, . . . , 29_{N} to a selected one of the DSP modems 30₁, . . . , 30_{M} which is not busy. The activity and accounting processor 93 and session switch 92 maintain the connection for either a predetermined time, perhaps determined by the user when initiating the session, or until activity ceases for a preset interval. The detected activity may be signalling exchanged between the AFE unit and a modem at the subscriber's premises when the subscriber attempts to begin a session or make a call.

A memory 94 is associated with the network interface unit 31 and the DSP modem pool 30. The network interface unit 31 may write to the memory 94 whereas the processors 30₁, . . . , 30_{M} can both write to, and read from, the memory 94. The memory 94 stores line codes, line condition information, and other operational data.

It is possible, therefore, to select different line codes from memory 94 for use by a particular DSP modem to process a particular digital signal. Indeed, if the DSP modem is fast enough to process several digital signals simultaneously, the same DSP modern may use different line codes simultaneously for the different digital signals. The line code selection may be initiated by the activity processor 93 in response to a demand from the user station when setting up the session. For example, the user station might select either Asymmetric DSL or Symmetric DSL according to the nature of the session.

The DSLAM shown in FIG. 16 allows any one of the DSL lines DSL₁, . . . , DSL_{N} to be connected to any one of the modems 30₁, . . . , 30_{M}. It is envisaged that, under normal traffic conditions, only ten per cent of the DSL lines DSL₁, . . . , DSL_{N} will be active so the number M of DSP modems need be only one tenth of the number N of DSLs.

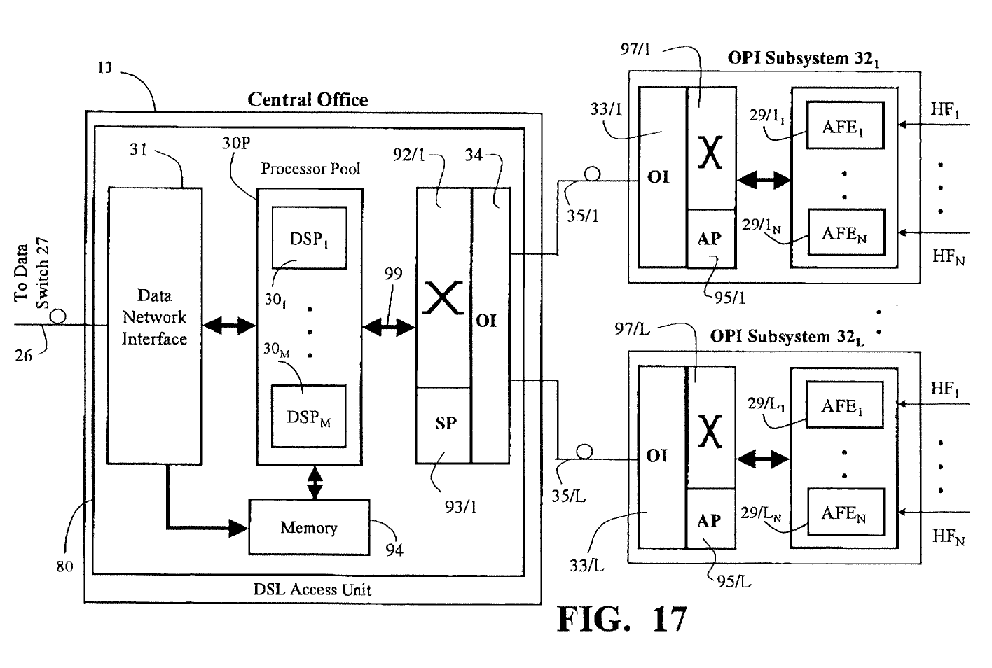

FIG. 17 illustrates a farther embodiment of the invention in which OPI subsystems 32₁, . . . 32_{L} having sets of analog interface units 29₁¹, 29_{N}¹; . . . 29₁ ^{L}, . . . 29_{N}^{L} and associated ones of circuit switches 97/1, . . . , 97/L and activity processors 95/1,. . ., 95/L, respectively, are physically separate, for example in different racks at different locations within the central office, but connected to a remote common DSP unit pool 30P in a DSL access unit 80 in central office 13. Optical interface units 33/1, . . . , 33/L, respectively, connect the circuit switches 97/1, . . . , 97/L, respectively, to the DSP pool 30P via optical fibers 35/1, . . . , 35/L, respectively. Each of the optical interface units 33/1, . . . , 33/L converts the digital signals of only the “active” DSLs from the corresponding group of interface units 29₁, . . . , 29_{N} into a serial optical signal and transmits the serial optical signal via the associated one of the optical fibers to the central office 13. In the central office 13, optical fibers 35/1, . . . , 35/L are connected to an optical interface unit 34 which converts the group of serial optical signals into electrical signals again and circuit switch 92, controlled by session processor 93, routes the electrical signals via a bus 99 to the bank of DSPs 30P.

In effect, the circuit switch 92 of the DSLAM shown in FIG. 16 has been divided into circuit switch unit 92/1 associated with the processor pool 3 0P and session switch units 97/1, . . . , 97/L, respectively. Likewise, the activity and accounting processor 93 shown in FIG. 16 has been replaced by an activity processor 93/1 associated with circuit switch 92/1 and activity processors 95/1, . . . , 95/L associated with circuit switches 97/1, . . . , 97/L, respectively.

In operation, each of the activity processors 95/1, . . . , 95/L will supply to the corresponding one of the user stations 10₁, . . . , 10_{L} a DSL tone, having a frequency higher than he limit of the lowpass filters, for example at least 25 kHz. The tone indicates that service s available. When a particular user station, say user station 10ₙ (not shown) in OPI subsystem 32₁, wishes to begin a session, it will detect the first tone and emit its own tone, requesting service. The activity processor 95/1 will detect the tone and send to the session processor 93/1 a request to set up a virtual connection via one of the DSP modems 30₁, . . . , 30_{M}. Assuming, for example, that DSP modem 30_{M} has free capacity, the session processor 93/1 will send a reply to the activity processor 95/1 to the effect that modem 30_{M} is to be used, whereupon activity processor 95/1 will advise the modem of user station 10ₙ that a connection is available and the user station may begin transmitting.

The session will continue until the user station 10, terminates it, perhaps by sending a suitable signal to activity processor 95/1 which then will send a signal to the session processor 93/1 advising it to terminate the virtual connection and, once the connection has been terminated, providing the DSL tone again on the corresponding DSL line. The DSL line then is available and the processor modem 30_{M} has capacity to handle another session. Alternatively, the activity processor 95/1 may cause termination if and when there has been no activity on the line for a predetermined “time out” period.

It should be appreciated that each of the DSPs implementing the modems 30₁, 30_{M} may process several signals simultaneously and that, as before, different line codes from memory 94 may be used for the different signals. An advantage of this arrangement is that it allows the user stations to select different line codes according to the kind of session being requested and, for example, the kind of bandwidth required. For example, a user might select Asymmetric DSL for Internet browsing and Symmetric DSL for networked video games or “video-on-demand”.

The selected DSP modem may demultiplex the serial digital signals for processing and then multiplex them again for transmission to the data network.

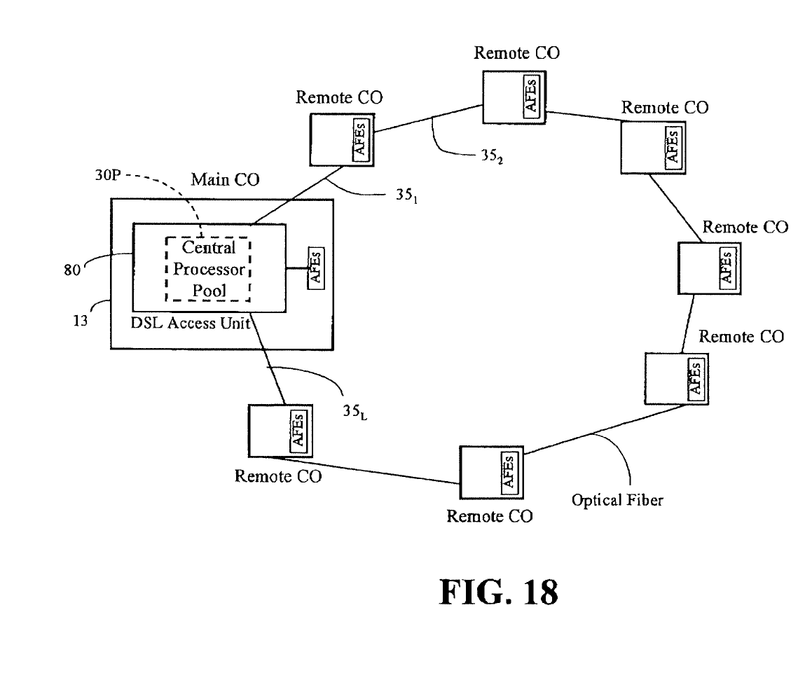

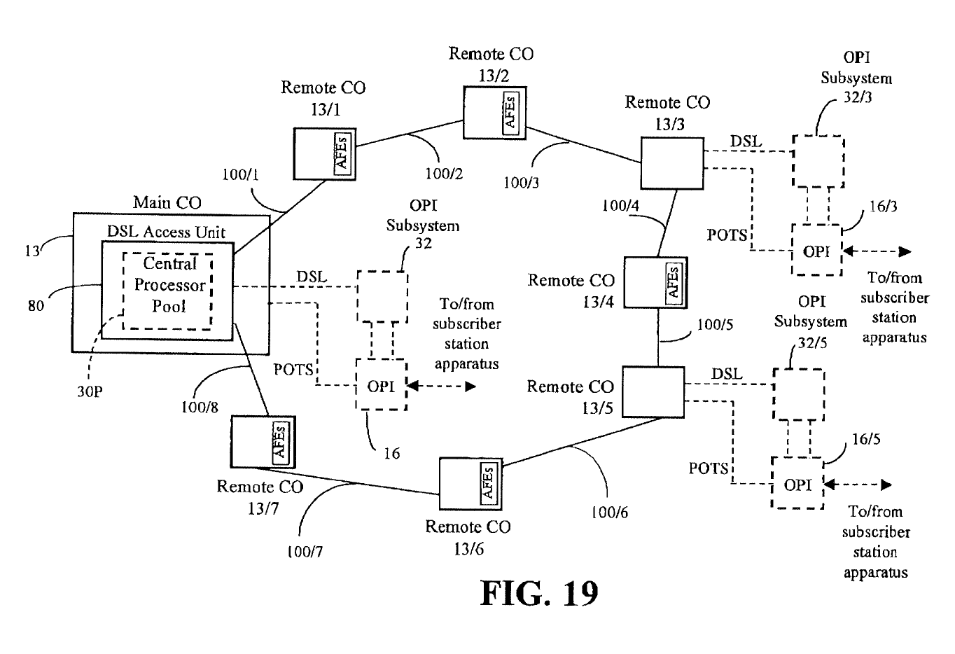

It is envisaged that, where the analog interface units are in physically separate groups, the groups need not be housed within the same central office but rather could be housed in other central offices or in distribution boxes or outside plant interface (OPI) units. Thus, FIG. 18 illustrates a system in which the DSP pool 30P is located in a main central office 13 and the groups 1 . . . L of analog interface units (AFES) are housed in respective ones of a plurality of remote central offices. The analog interface units and the central DSP modem pool unit 30P of DSL Access unit 80 will be similar to those shown in FIG. 17. In this case, however, the optical fibers 35₁, . . . , 35_{L} interconnect the groups of interface units in a ring configuration. While such a ring connection is particularly suitable when the data network is a SONET network, it should be appreciated that alternative interconnection configurations could be used instead.

As described with reference to FIGS. 1 and 2, the existing individual subscriber loops are connected via “drop boxes” and distribution cables to outside plant interface (OPI) boxes, which themselves are connected to the central office. Where, as described with reference to FIGS. 3 to 5, the analog interface units 291₁. . . , 29_{N} (FIG. 4) and the POTS splitters 22 (FIG. 4) are disposed in or adjacent the OPI boxes and coupled to the associated local central office 13 by an optical cable, the processor pool(s) could be at the local central office and/or at the main central office; or even elsewhere. Thus, a small processor pool could be located at the local central office and a main processor pool be provided at, or accessible via, the main central office to provide overflow capacity. Such an alternative system will now be described with reference to FIG. 19.

In the system shown in FIG. 19, the main central office 13 is coupled to a plurality of remote or local central offices 13/1, 13/2, . . . , 13/7 by trunks 100/1, 100/2, 100/3, . . . , 100/8 in the usual way. The main central office 13 has a central processor pool 30P similar to that shown in FIG. 17 and several of the local central offices 13/1, 13/2, 13/4, 13/6 and 13/7 have analog interface units similar to those shown in FIG. 3 and 9 with AFE POTS splitter (not shown in FIG. 12) similar to those shown in FIG. 4. Generally, these central offices will have subscriber stations so close that the subscriber loops are short enough to support high speed access. The main central office 13 and two local central offices 13/3 and 13/5, however, are shown connected to OPI subsystems 32, 32/3 and 32/5, respectively, located in or adjacent OPI boxes 16, 1613 and 16/5 which, typically, connect to subscriber stations that are more distant than, say, 2 kilometers from the main central office 13. Each of the OPI subsystems 32, 32/3 and 32/5 includes a bank of analog interface units similar to those described hereinbefore with reference to FIG. 17 and a bank of POTS splitters 22, each for separating DSL and POTS signals passing between the local central office and the associated one of the subscriber stations.

Central offices 13, 13/3 and 13/5 each will be configured like that shown in FIG. 3, but with the DSP modem unit 30 and optical interface unit 34 replaced by those shown in the central processor pool shown in FIG. 17. The arrangement at the OPI unit may be as shown in FIG. 4.

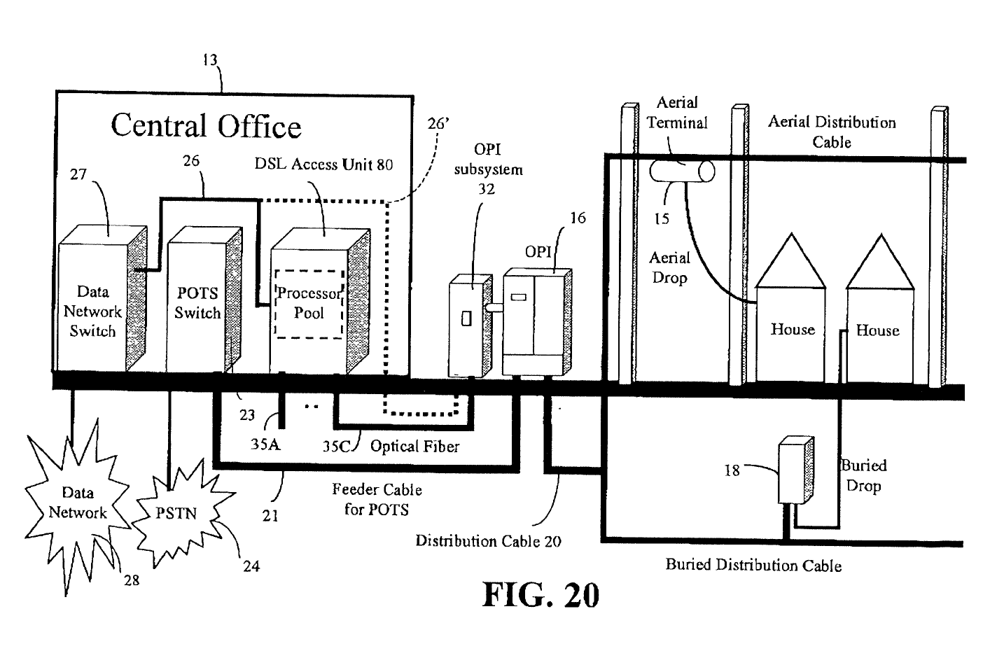

Although it is unlikely at present that the DSL signals from the various OPI subsystems will exceed the capacity of the DSL access unit(s) 80 at the central office 13, it would be possible to couple one or more of the OPI subsystems 32 directly to the data network interface unit 42, by-passing the DSL access unit 80 or AFE/modem units or DSLAMs, by an optical fiber 26′, shown as a broken line in FIG. 20. In order to permit selection of the alternative or bypass optical fiber 26′, the OPI subsystem would include the switch 90, as shown in FIG. 14.

Preferably, each of the AFEs in a particular group has variable gain so as to allow adjustment of signal levels in the cable and reduce cross talk and other interference to which the user signals might be subjected.

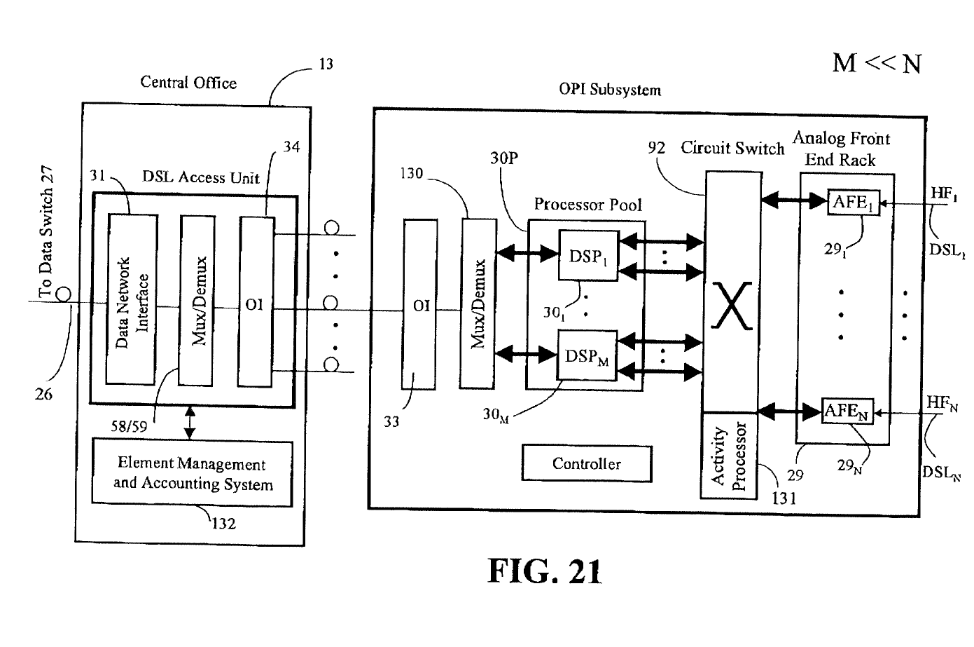

The embodiments shown in FIGS. 6 and 11 locate the DSP modems 30₅¹, . . . 30₅³² at the OPT subsystem 32, which is desirable because it reduces demand on bandwidth of the optical fiber 35. Unfortunately, size constraints may make it difficult to locate a large number of such DSP modems at the OPI subsystem 32. Accordingly, it may be preferred to provide a DSP modem pool 30P at the OPT subsystem 32 and share the DSP modems between the subscriber lines. As shown in FIG. 21, the OPI subsystem 32 then would be similar to that shown in FIG. 16 but with the data network interface 31 replaced by an optical interface (OI) unit 33 and a multiplexer/demultplexer 130. In addition, the activity and accounting processor 93 of FIG. 16 is replaced by an activity processor 131, and the accounting function will be handled by a processor 132 at the central office 13. Otherwise the equipment at the central office 13 will be as shown in FIGS. 6 and 11, including optical interface 34, multiplexer and demultiplexer 58/59 (shown as one box for convenience and data network interface 31.

As in the embodiment of FIG. 16, the OPI subsystem comprises a circuit switch 92 for selecting an available one of the DSP modems 30₁, . . . , 30_{M} in dependence upon activity detected by the activity processor 131.

Usually, very long subscriber loops, e.g. longer than 5 or 6 kilometers, will have a loading coil which will preclude high speed data transmissions. At present, a technician must go to the OPI 16 to connect a time domain reflectometer (TDR) to the subscriber loop to test it to determine whether the loop is unsuitable because of such a loading coil or other deficiency, such as bridge taps, which will limit its ability to handle DSL transmissions. A significant advantage of embodiments of the present invention, wherein the POTS splitter and high speed interface are located at the OPI 16, is that time domain reflectometry measurements to test individual loops can be made from the local or main central office, or even elsewhere in the network. For example, a processor, such as one of the DSPs, could run software for generating the required TDR signal and transmitting it via the session switch, optical fiber, and activity switch to the appropriate one of the AFEs at the OPI 16, which would transmit the corresponding electrical pulses onto the subscriber loop and return the reflections signals to the DSP for processing to derive the loop characteristics and suitability for high speed data, or lack thereof

It should be noted that the invention is applicable to “voice over DSL” systems, in which case the POTS splitter unit would be omitted and the DSLAM parts modified appropriately.

Embodiments of the first aspect of the invention allow DSL service to be provided for a greater number of subscribers at reasonable cost. It will be appreciated that embodiments of the present invention using DSP-sharing require less costly equipment, specifically fewer modems, than existing designs and can be upgraded relatively easily. A significant advantage is that the line codes can, if desired, be selected on a “per call” basis and the set of line codes form which the selection is made, i.e. stored in memory 94, can be changed relatively easily, which facilitates upgrading to accommodate new line codes or simply changing line codes according to specific requirements. An advantage of embodiments of the invention in which the DSLs share DSP modems is that they avoid the redundancy which results from inactive DSLs being connected, as in prior art DSL access arrangements.

1. Access apparatus for connecting to a data network (28) a plurality of digital subscriber lines (DSL₁, . . . ,DSL_{N}) for carrying high frequency analog signals (HF₁, . . . HF_{N}) to and from subscriber stations (12₁, . . . , 12_{N}), said apparatus comprising a local part and a remote part and means (33, 34, 58, 59) for communicating signals between the local part and remote part via a high speed link the local part adapted for location at a central office (13) and comprising a data network interface unit (31) for exchanging digital data signals with said data network via a data switch (27), said remote part being adapted for location at a position intermediate the central office and said subscriber stations and comprising an analog interface unit (29), the apparatus further comprising a modem unit (30) in one of said local part and remote part and between the data network interface unit (31) and said analog interface unit (29), said analog interface unit (29) for converting said high frequency analog signals into modulated digital signals and vice versa, and said modem unit for demodulating said modulated digital signals to form digital data signals for supply to said data network interface unit and for modulating said digital data signals to form said modulated digital signals for supply to said analog interface unit.

2. Access apparatus according to claim 1, wherein the modem unit (30) is in the local part and coupled to the analog interface unit (29) by way of said interface means (33, 34) and said high speed link.

3. Access apparatus according to claim 2, wherein said high speed link includes an optical fiber cable (35C) and said interface means (33, 34) comprises local (34) and remote (33) optical interface units at the local part and remote part, respectively.

4. Access apparatus according to claim 1, wherein said data network interface unit is in a digital subscriber line access multiplexer (DSLAM) (25) that processes said digital data signals to form high frequency analog signals, and vice versa, and said local part further comprises an additional analog interface unit (29A) for converting high frequency analog signals received from said DSLAM (25) to modulated digital signals and supplying said modulated digital signals to said interface means (34), or converting modulated digital signals received via said interface means (34) from the analog interface unit (29) at the intermediate position into high frequency analog signals and supplying said high frequency analog signals to said DSLAM (25)

5. Access apparatus according to claim 1, wherein said modem unit (30) is in said remote part and said interface means (33, 34; 58, 59) comprises a local interface unit (34) and first multiplexer/demultiplexer unit (58, 59) at said local part and a remote interface unit (33) and a second multiplexer/demultiplexer units (63, 64) at said remote part, the first and second multiplexer/demultiplexer units being operable to multiplex said digital data signals for transmission via said local and remote interface units and said high speed links and the demultiplexers being operable to demultiplex received multiplexed digital data signals.

6. Access apparatus according to claim 4, wherein said modem unit (30) also is in said remote part, and said first part further comprises an additional modem unit (30A), said additional analog interface unit (29A) supplying said modulated digital signals to said additional modem unit (30A) which demodulates said modulated digital signals and supplies the resulting digital data signals via said interface means (33, 34) to the modem unit (30) in said remote part, said additional modem unit (30A) modulating digital data signals received from said modem unit (30) and supplying the resulting modulated digital signals to said additional analog interface unit (29A).

7. Access apparatus according to claim 1, wherein said modem unit (30) also is in said remote part and exchanges said digital data signals with said data network interface unit (31) via said interface means (33, 34).

8. Access apparatus according to claim 1, wherein said local part comprises a plurality of said interface units (82₂,. . ., 82_{M}) for receiving digital data signals from said remote part, each of said interface units (82₂, . . . , 82_{M}) processing said digital data signals to form a different kind of signal for output via a respective one of a set of additional interface units (84-87).

9. Access apparatus according to claim 8, wherein said central office (13) further comprises a digital subscriber line access multiplexer (DSLAM) and said additional interface units comprise a DSLAM interface unit (84) comprising a modem unit and an analog interface unit for converting digital data signals received from the second part into high frequency analog signals and supplying same to said DSLAM (25).

10. Access apparatus according to claim 8, wherein said interface units (82₂, . . . , 82_{M}) are greater in number than said additional interface units (84-87) and the apparatus further comprises switching means (83) for coupling selected ones of the first mentioned interface units (82₂, . . . , 82_{M}) to said additional interface units (84-87).

11. Access apparatus according to claim 1, wherein said interface means comprises one or more optical interface units (33₂, 33₃, 33₄) in said remote part, said analog interface unit (29) in said remote part comprises a plurality of said analog interface circuits (61₂, . . . , 61_{N}) each coupled to a respective one of a plurality of subscriber stations and greater in number than said optical interface units (32₂, 33₃, 34₄) and said remote part further comprises a selection switch unit (90) for coupling said analog interface circuits selectively to said optical interface circuits.

12. Access apparatus according to claim 8, wherein said local part comprises a first access unit (80/1) and a second access unit (80/2) the apparatus further comprises at least one second remote part (32/2), the first mentioned remote part (32/1) being connected to the access units by first and second high speed communications links respectively, and the second remote part (32/2) being connected to the first and second access link by two additional high speed communication links, respectively.

13. Access apparatus according to claim 7, wherein each modem unit (30) comprises a plurality of modems (30¹₂, . . . , 30³²₃; . . . 30¹₅, . . . , 30³²₅) each for modulating user-specific digital data signals received from said data network interface unit to form corresponding user-specific modulated digital signals and demodulating user-specific modulated digital signals received from said analog interface unit to form said user-specific digital data signals.

14. Access apparatus according to claim 1, wherein said intermediate position is at a junction where a feeder cable (21) from the central office (13) is coupled to several distribution cables (19A, 19B₂₁), each of which is connected to several subscriber loop sections (17_{N}), each connected to a respective one of said subscriber stations (10₁, . . . , 10_{N}).

15. Apparatus according to claim 1, wherein a POTS splitter/combiner is provided to receive the high frequency analog signals from the analog interface unit (29) and POTS signals from a POTS switch and convey either or both to the subscribers, or vice versa.

16. Apparatus according to claim 1, wherein the modem unit (30) comprises a set of one or more digital signal processor (DSP) modem units (30₁, . . . , 30_{M}) for processing the digital data signals and routing the processed signals to the data network and for processing signals from the data network and supplying the resulting digital signals to respective ones of the interface units, and switching means (92) for connecting the DSP modem units selectively to the subscriber lines for at least the duration of a call.

17. Access apparatus according to claim 16, wherein the DSP modem units use different line codes for different ones of the plurality of digital signals.

18. Apparatus according to claim 16, wherein the switching means (92) comprises a circuit switch unit for making virtual connections between respective ones of the analog interface unit (29, . . . , 29_{N}) whose associated subscriber lines are active and said one or more DSP modem units, the circuit switch unit maintaining each said connection for the duration of a session or call.

19. Apparatus according to claim 16, further comprising an activity processor (93) for detecting whether or not said subscriber lines are active, the circuit switch unit (92) selecting a particular line in response to a signal from the activity processor indicating that the line is active.

20. Access apparatus for connecting a plurality of DSL lines to a data network (28), comprising
(i) a plurality of analog interface units (29, . . . 29_{N}) connected to a plurality of DSL lines, respectively, for converting DSL signals to modulated digital signals, or vice versa.
(ii) a set of one or more digital signal processor (DSP) modem units (30₁, . . . , 30_{M}) for processing the modulated digital signals and routing resulting digital data signals to the data network and for processing digital data signals from the data network and supplying the resulting modulated digital signals to respective ones of the analog interface units, and
(iii) circuit switching means (92) for connecting the DSP modem units selectively to the DSL lines for at least the duration of a call.

21. Apparatus according to claim 20, wherein the switching means (92) comprises a circuit switch unit for making virtual connections between respective ones of the interface units whose associated subscriber lines are active and said one or more DSP modem units, the circuit switch unit maintaining each said connection for the duration of a session.

22. Apparatus according to claim 20, further comprising an activity processor (93) for detecting whether or not said subscriber lines are active, the circuit switching means (92) selecting a particular line in response to a signal from the activity processor indicating that the line is active.

23. Access apparatus according to claim 20, wherein a plurality of said DSP modem units (30₁, . . . , 30_{M}) are connected to the switch unit (92) and the switch unit is operable to select any one of the DSP modem units for connection to a particular active DSL.

24. Access apparatus according to claim 20, wherein each analog interface unit is arranged to exchange signalling with a user station connected thereto by the associated subscriber line so as to set up a session and maintain the connection therebetween, and the apparatus further comprises an activity processor (93) associated with the switching means for detecting said signalling as user activity indicative of an attempt to establish a session and connecting the corresponding subscriber line to said one of the DSPs.

25. Access apparatus according to claim 24, wherein the activity processor (93) is arranged to permit, in normal circumstances, the duration of the session to be determined by a user station connected to the line.

26. Access apparatus according to claim 25, wherein the activity processor (93) is arranged to permit the user to set a predetermined session duration when initiating the session.

27. Access apparatus according to claim 24, wherein the activity processor (93) is arranged to determine session duration by terminating the session when there has been no activity for a predetermined interval.

28. Access apparatus according to claim 25, wherein the activity processor is arranged to terminate the session in response to a termination request from the user station.

29. Access apparatus according to claim 20 wherein said one or more DSP units are each arranged to process signals from several of the DSL lines simultaneously.

30. Access apparatus according to claim 29, wherein said one or more DSP modem units use different line codes for different ones of said signals.

31. Access apparatus according to claim 20, further comprising memory means (94) for storing a selection of different line codes for use by said one or more digital signal processors modem units, the or each digital signal processor modem unit using a particular one of the line codes in dependence upon the particular digital signal to be processed thereby.

32. Access apparatus according to claim 31, further comprising means for loading said line codes into said memory.

33. Access apparatus according to claim 31, wherein said particular one of the line codes is selected in dependence upon information supplied by a corresponding interface unit when the session is being initiated.

34. Access apparatus according to claim 20, comprising a plurality of groups of said analog interface circuits, the analog interface circuits in a particular group being connected to at least one said DSP unit by means of a high bandwidth communications channel (35/1, . . . , 35/L).

35. Access apparatus according to claim 34, wherein the high bandwidth communications channel uses optical transmission.

36. Access apparatus according to claim 34, wherein the groups of interface circuits are each at a different physical location within the same central office (13).

37. Access apparatus according to claim 34, wherein at least one of the groups of interface circuits is at a physical location remote from the central office.

38 Access apparatus according to claim 34, wherein the groups of interface circuits are each located at a different central office.

39. Access apparatus according to claims 34, wherein each group of analog (interface circuit group comprises means for extracting the digital signals of active DSL lines and is associated with an optical fiber interface (33/1,. . ., 33L) for effecting parallel to serial conversion of said digital signals and routing the serial digital signals via the high bandwidth link communications channel.
